(19) United States
(12) Patent Application Publication
(10) Pub. No.: US 2022/0406215 A1
(43) Pub. Date: Dec. 22, 2022

(54) SYSTEMS AND METHODS FOR DYNAMICALLY PROVIDING DYNAMIC NUTRITIONAL GUIDANCE

(71) Applicant: Inspiring Healthcare, LLC, Oakland, CA (US)

(72) Inventors: Thomas Gregory Quinn, Oakland, CA (US); Randi Gallenson, Oakland, CA (US); Allan Day Sapp, Gardnerville, NV (US); Stephen Raskin, Oakland, CA (US); Susan Miriam Brand, Richmond, CA (US); Venkateswara Rao Vaddineni, San Jose, CA (US); Daphna Karen Dror, Belmont, CA (US); Daniel C. Cannon, Albuquerque, NM (US)

(21) Appl. No.: 17/856,782

(22) Filed: Jul. 1, 2022

Related U.S. Application Data
(63) Continuation-in-part of application No. 15/967,268, filed on Apr. 30, 2018.
(60) Provisional application No. 62/492,925, filed on May 1, 2017.

(51) Int. Cl. G09B 19/00; G06Q 30/06

(52) U.S. Cl. CPC G09B 19/0092; G06Q 30/0633

(57) ABSTRACT

The present invention relates to systems and methods for providing dietary recommendations to a user is provided. In this method palate preferences, physiological data and dietary constraints are received for a user. This data is used to generate a nutritionally optimized meal plan based upon macronutrient and micronutrient requirements. The optimized meal plan is cross referencing against the palate preferences and dietary constraints to identify dietary elements within the optimized meal plan that are in conflict with the palate preferences and dietary constraints. These conflicting ingredients/dishes may be substituted for with meals that meet the same dietary requirements. The system outputs the meal plan and recipes for the meal plan to the user. The user then leverages this information in their daily food intake, and provides feedback to the system regarding their compliance with the meal plan. Two or more nutritional scores are generated for the user based upon this feedback.

### CROSS REFERENCE TO RELATED APPLICATIONS

This U.S. Application is a Continuation-in-Part Application of U.S. Application No. 15,967,268 filed Apr. 30, 2018, pending, which claims the benefit of U.S. Provisional Application No. 62/492,925 filed May 1, 2017, expired, both applications are incorporated herein in their entirety by this reference.

### BACKGROUND

The present invention relates to systems and methods for holistically and dynamically managing metabolomics, leading to improvement of users' overall health.

Humans require a diverse set of macronutrients and micronutrients to maintain a healthy diet. Additionally, in addition to their diversity, specific amounts/proportions and ratios of many of these nutrients is also required to ensure a good diet.

Proper nutrition is a requisite to being healthy, however many people subsist on extremely poor diets. This is because the prevalence of processed foods renders maintaining proper nutrition difficult (due to convenience and/or palate preferences). This trend of poor dietary considerations is compounded by the lack of proper nutritional guidance.

There are many “one size fits all” dietary regimens available to individuals. These diets include high protein diets and detox diets, as well as general guidance such as the ‘food pyramid’. In some cases, organizations (such as the American Heart Association) provide more granular guidance, however these guidelines still leave the decision making of what foods to consume largely in the hands of the individual.

More recently, some meal planning programs have emerged. Generally, these meal-planning services are hyper-focused upon caloric intake and weight loss (e.g., Weight Watcher and the like). The nutritional value of the foods to meet very specific macro and micro nutritional requirements, while within palate preferences and dietary restrictions, is not addressed, or at best of secondary concern.

Further, particular pathological states may be prevented or treated through very specific nutritional regiments. Again, aside from general guidance from a physician (e.g., “eat more fish”, “cut your salt intake”), there is little direction available to the individual to properly manage their diet in a manner tailored to their specific needs.

It is therefore apparent that there is a longstanding and significant need for a system for nutritional planning that allows for the tailoring of a diet to an individual that is responsive to their dietary restrictions as well as their palate preferences. Such an improved approach will enable users to tailor metabolomic regimens by integrating best practices and knowledge into novel paradigms thereby substantially improving their long term health and resulting quality of life.

### SUMMARY

To achieve the foregoing and in accordance with the present invention, systems and methods for holistically and dynamically managing metabolomics is provided. In particular the systems and methods for balancing macronutrients and/or micronutrients consumption with resulting metabolomic benefits.

In one embodiment of the MedChefs Ecosystem, a computerized method for providing dietary recommendations to a user is provided. In this method palate preferences, physiological data and dietary constraints are received for a user. This data is used to generate a nutritionally optimized meal plan based upon macronutrient and micronutrient requirements. The optimized meal plan is cross referencing against the palate preferences and dietary constraints to identify dietary elements within the optimized meal plan that are in conflict with the palate preferences and dietary constraints. These conflicting ingredients/dishes may be substituted for with meals that meet the same dietary requirements.

The system then determines what sort of computing platform the user is leveraging in order to output the meal plan and recipes for the meal plan to the user. This includes formatting the data for the given computing device. The user then leverages this information in their daily food intake, and provides feedback to the system regarding their compliance with the meal plan. Two or more nutritional scores are generated for the user based upon this feedback. These scores may be augmented with an activity level metric. One of the scores may include a consumption characterization score, which is calculated as a point for each of consuming greater than approximately 25 grams of fiber in a 24 hour period, and consuming no greater than 2 servings of processed meats per 7 day period.

Curated resources are also made available to the user. These curated resources may be responsive to the user's physiological data. In addition to feedback from the user, other independently verified data may be collected regarding the user. This data may include feedback from a doctor/coach/therapist/etc. It may also include feedback from a wearable device, smart watch, smart scale, smart exercise equipment and the like.

In some embodiments, a value-add service may be provided to the user. Such value-added service includes at least one of the automated generation of a shopping list, a grocery delivery service, a meal preparation service, and a coaching service.

In some embodiments a chromatic analysis of food consumed may also be leveraged to generate a score for the food. First a digital image of a meal is received. The color spectrum for the food is parsed. If the color portions versus the black/beige portions are above a threshold then a score for the food may be generated.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is a block diagram showing one embodiment of a MedChefs Ecosystem, in accordance with the present invention;

FIG. 2 is a flow diagram illustrating the functionality of the embodiment of the MedChefs Ecosystem of FIG. 1;

FIGS. 3A-3H, 3J-3N and 3P are screenshots illustrating the functionality of the embodiment of MedChefs Ecosystem of FIG. 1;

FIG. 4 is another block diagram illustrating workflow and potential partnerships for the MedChefs Ecosystem of FIG. 1;

FIG. 5 is a block diagram of a MedChefs system architecture embodiment for the Ecosystem of FIG. 1;

FIG. 6 is a block diagram for an example embodiment of the elastic MedChefs server(s);

FIG. 7 is an example swim-lane diagram for the authentication process;

FIG. 8 is a flow diagram for an example process of MedChefs operation, in accordance with some embodiments;

FIG. 9 is a flow diagram for an example process of dietary score generation, in accordance with some embodiments;

FIG. 10 is a flow diagram for an example process of resources presentation, in accordance with some embodiments;

FIG. 11 is a flow diagram for an example process of objective data collection, in accordance with some embodiments;

FIG. 12 is a flow diagram for an example process of value add service delivery, in accordance with some embodiments;

FIGS. 13-49 are example screenshots of the MedChefs system in operation, in accordance with some embodiments; and

FIGS. 50A and 50B provide example computer systems capable of performing the processes described herein, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “always,” “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

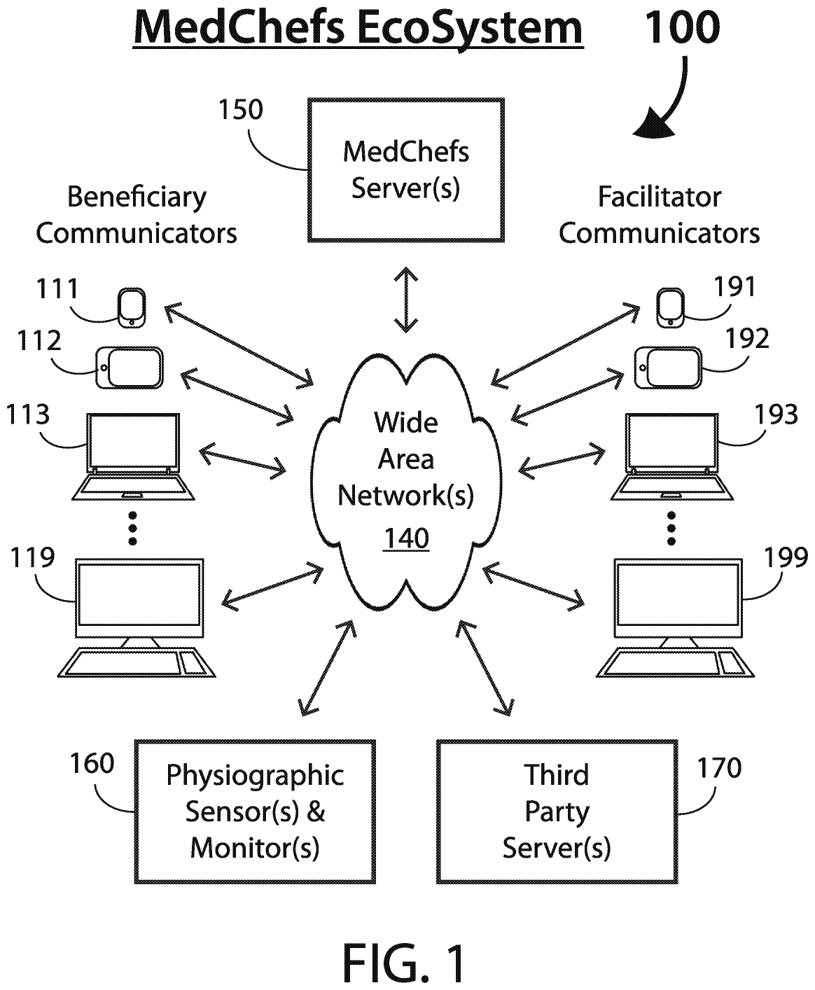

To facilitate discussion, FIG. 1 is a block-diagram of an exemplary MedChefs Ecosystem 100 illustrating systems and methods for holistically and dynamically managing metabolomics for a plurality of beneficiaries (not shown) over wide area networks 140 (WANs) via any of a wide assortment of electronic network terminal devices, e.g., Beneficiary Communicators 111, 112, 113, . . . 119 and Facilitator Communicators 191, 192, 193, . . . 199. In the process of describing various exemplary embodiments, particular attention may be placed upon visual displays on mobile communication devices such as smart phone 111. It is also contemplated that communications can be accomplished with many alternate forms of consumer electronic networked devices including, but not limited to, computers, tablet computer systems, e-reader devices, and virtually any electronic device which includes networking capability and a user interface.

While specific examples of visual user interfaces are described in great detail, MedChefs Ecosystem 100 may be implemented with a wide range of interface types, including any combination of a visual display, tactile and audio output and a visual, tactile or acoustic user interface (UI). Further, although the Internet is a well-known convenient channel for communication between beneficiaries and facilitators, Ecosystem 100 may also utilize equivalent communication over other WANs using services such as, but not limited to, Public Switched Telephone Network (PSTN), Voice over Internet Protocol (VoIP), Skype, WhatsApp, Facebook, SnapChat and Twitter.

Exemplary Communicators, 111-119 and 191-199 represent the multiplicity of devices that can support access to MedChefs Server(s) 150 of Ecosystem 100. Often these communication devices are mobile devices—i.e., devices that can be carried easily from place to place by a beneficiary or a facilitator—typically with Wi-Fi or cellular data or other wireless connectivity and in numerous instances with built-in mobile telephone capability. However, less portable or fixed installation terminals may also support access to MedChefs Server(s) 150.

In addition to managing the nutritional needs of beneficiaries, MedChefs Ecosystem 100 can adaptably enable a wide range of functionality such as: to advertise and offer Nutrition-related Goods and Services (NGS), accumulate independent third-party assessments and reviews, display credentials, leverage the draw of a centralized need-targeted electronic directory, offer informative mini-tutorials and FAQs, update and display availability status, prequalify prospective beneficiaries, provide repeatable direct beneficiary-facilitator communication, arrange for commercial transactions, facilitate and track progress towards consummating commercial transactions, consummate transactions for NGS, follow-up post-transaction with beneficiaries to encourage and enhance good-will, and measure and evaluate the effectiveness of the foregoing and make adjustments and refinements. Some of the supplemental functionality of MedChefs Ecosystem 100 can be supported by third parties resources via for example Third Party Server(s) 170.

Accordingly, MedChefs Ecosystem 100 provides a unified adaptable facility for beneficiaries, to prequalify, locate, evaluate, make repeatable contact with, and acquire NGS, from, one or more nutritional facilitators. NGS can also include nutritional advice and nutrition related information from the facilitators and/or third parties, which may or may not be vetted and/or certified by the MedChefs Ecosystem 100.

Nutritional beneficiaries can be any member(s) of the general population, ranging from healthy toddlers to Alzheimer patients in nursing homes. Beneficiaries can be served as individuals or in groups, including families and communities such as sororities, fraternities, cooperatives, neighborhoods and/or communes. Nutritional facilitators include, but are not limited, to physicians (MDs and DOs), nurse practitioners, pharmacists, nurses, physiotherapists, chiropractors, herbalists, nutritionists, dieticians, caregivers, chefs, food suppliers, delivery services, trainers and motivators.

Referring again to FIG. 1, exemplary Beneficiary Physiologic Sensors and/or Monitors 160 include both personal and communal devices such as sphygmomanometers, metabolic monitors (e.g., blood glucose monitors/sensors and insulin pumps), hydration monitors/sensors, cholesterol monitors/sensors and endothelial function assessors.

Other potentially useful sensors include thermometers, oximeters, and renal function devices liver function monitors capable of measuring, for example, enzymatic liver function capacity and plasma disappearance rate (PDR).

In addition, food, ranging from raw basic ingredients to complete meals, can also be tracked electronically, with the aid of for example RFID scanners, barcode scanners, and cameras.

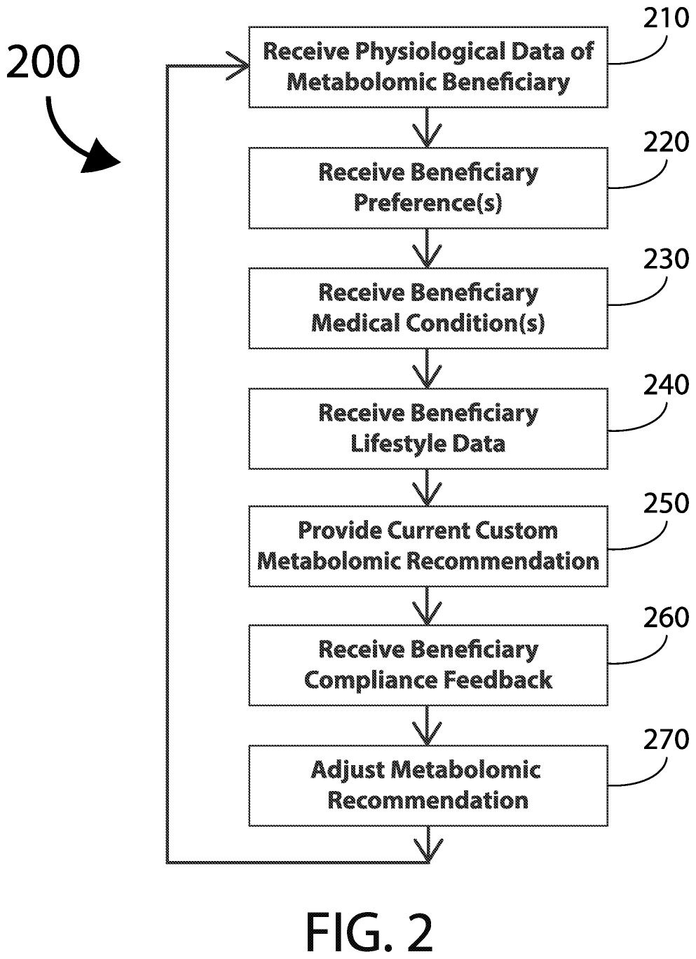

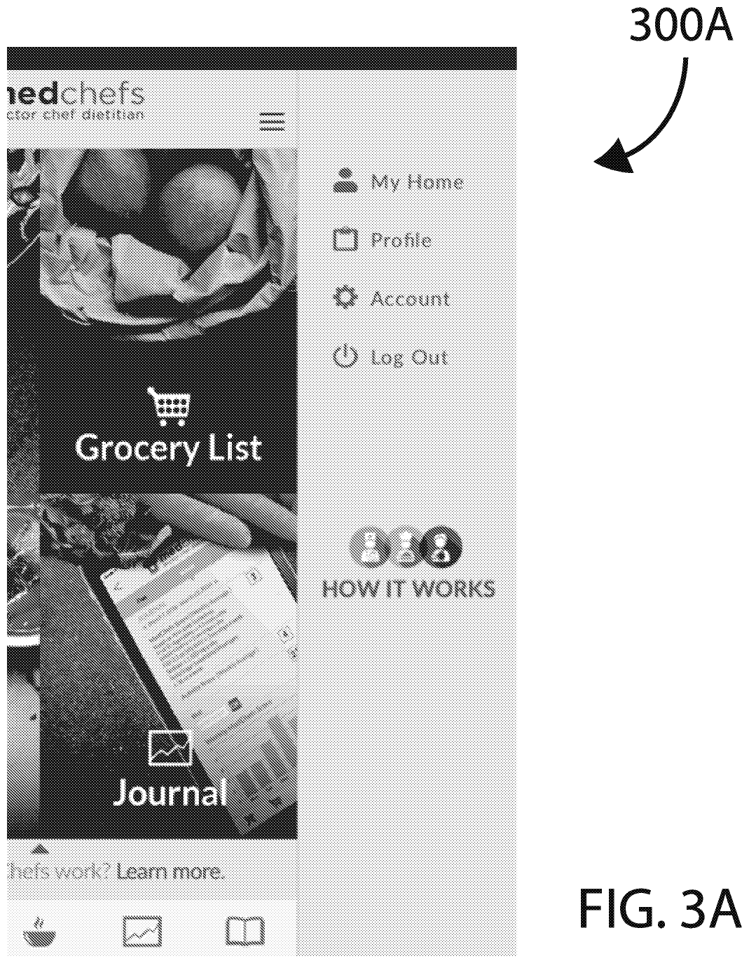

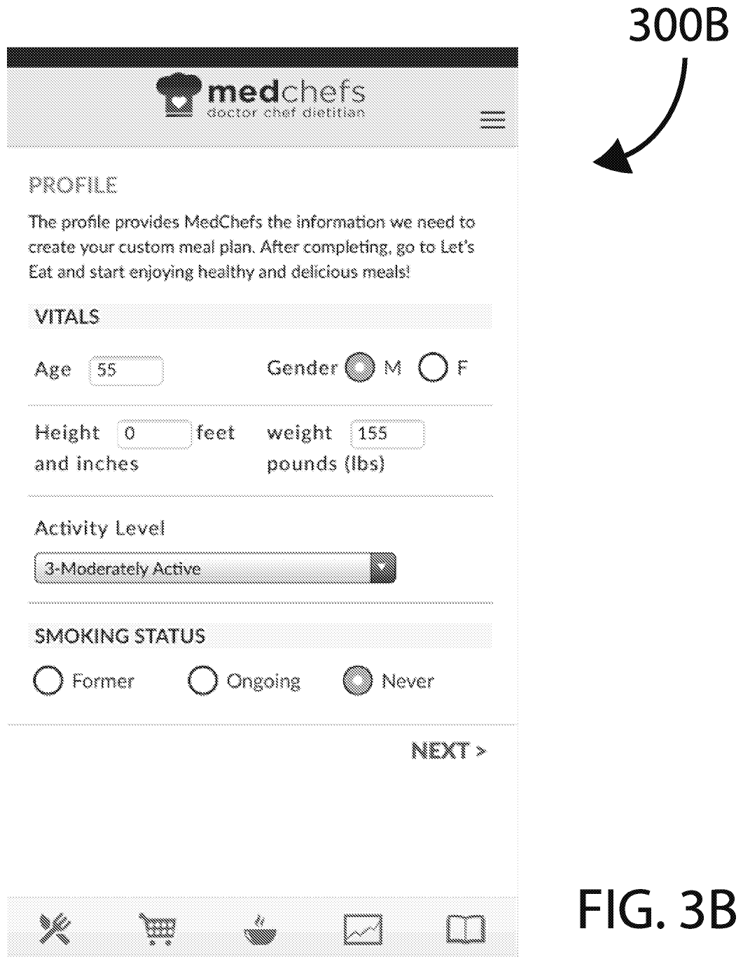

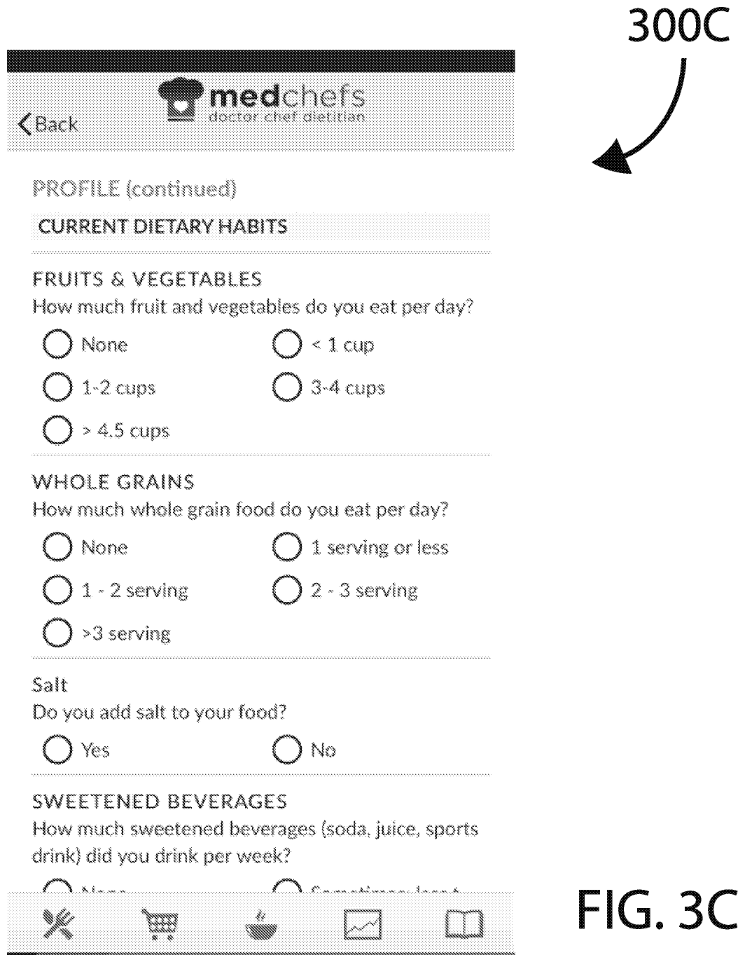

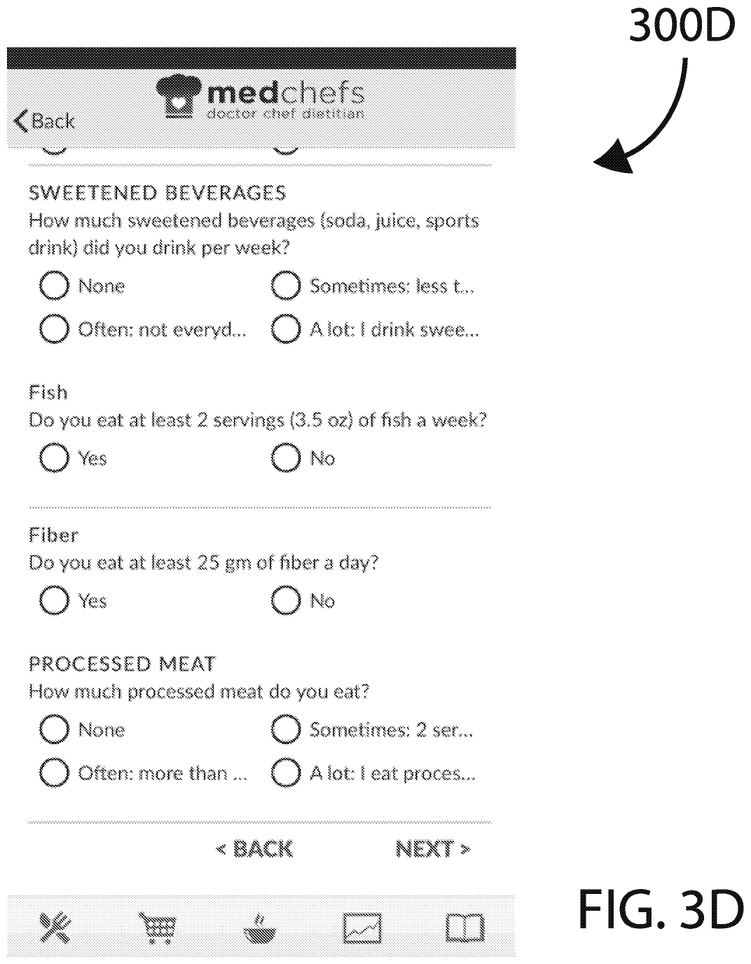

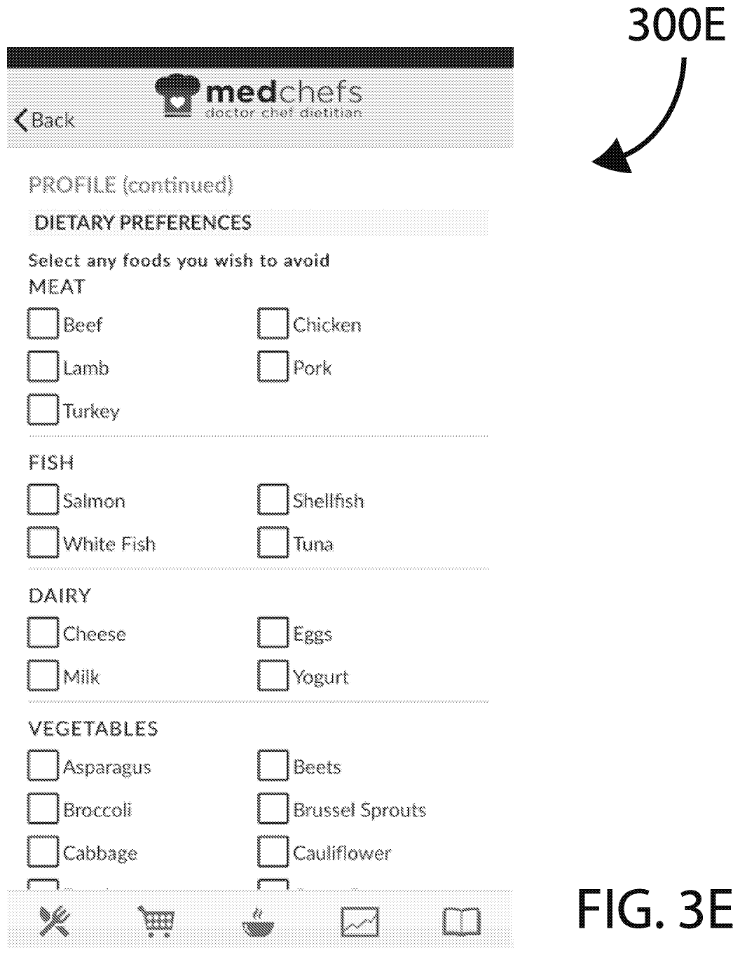

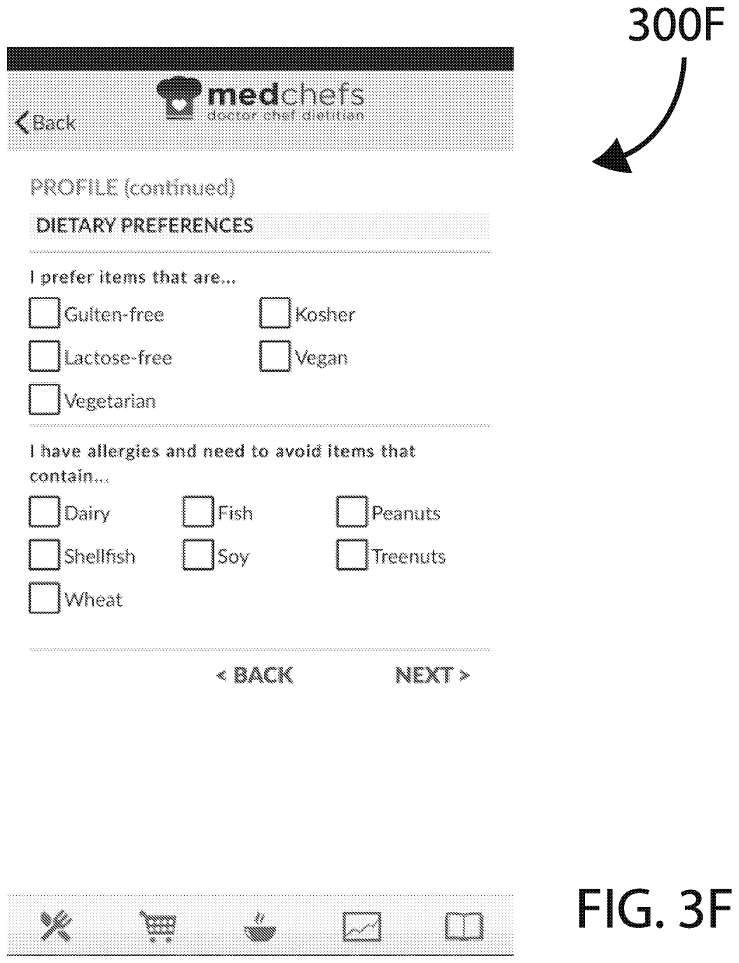

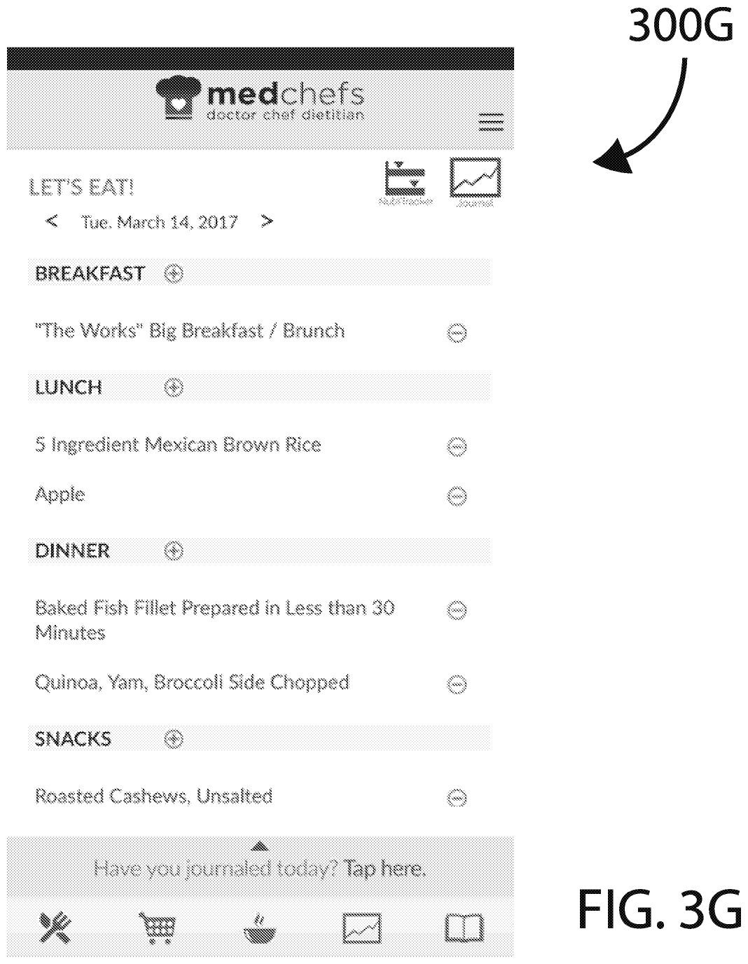

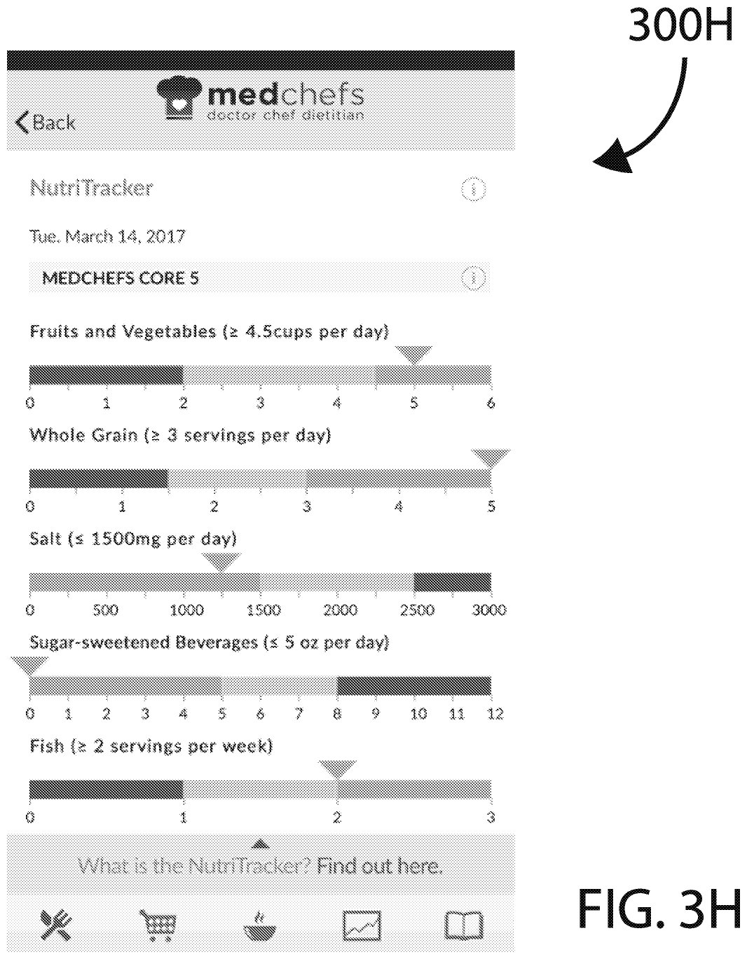

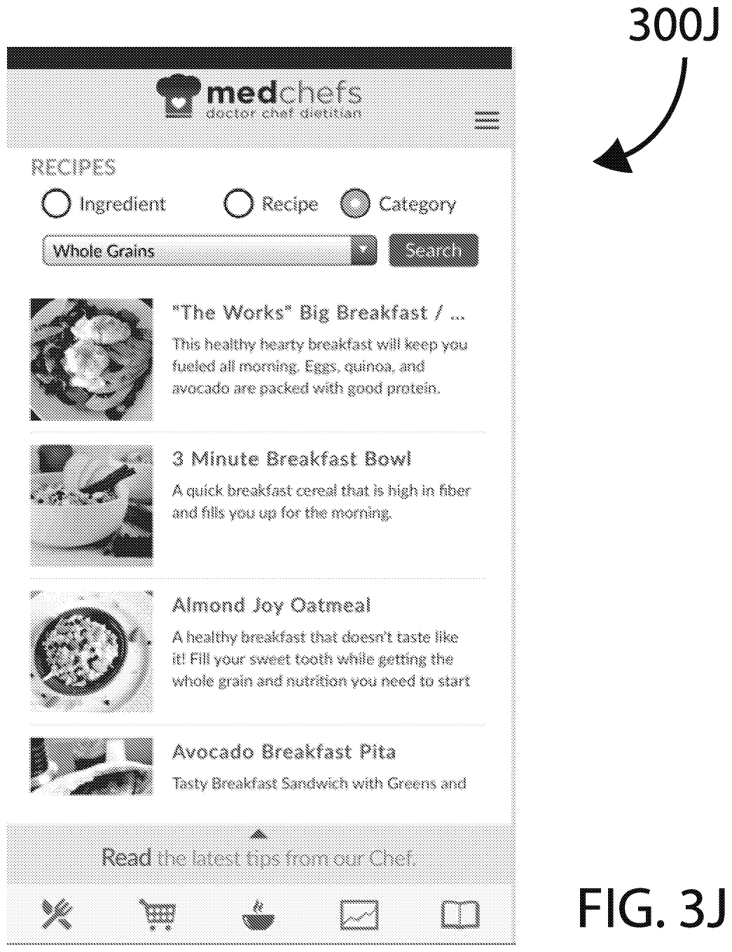

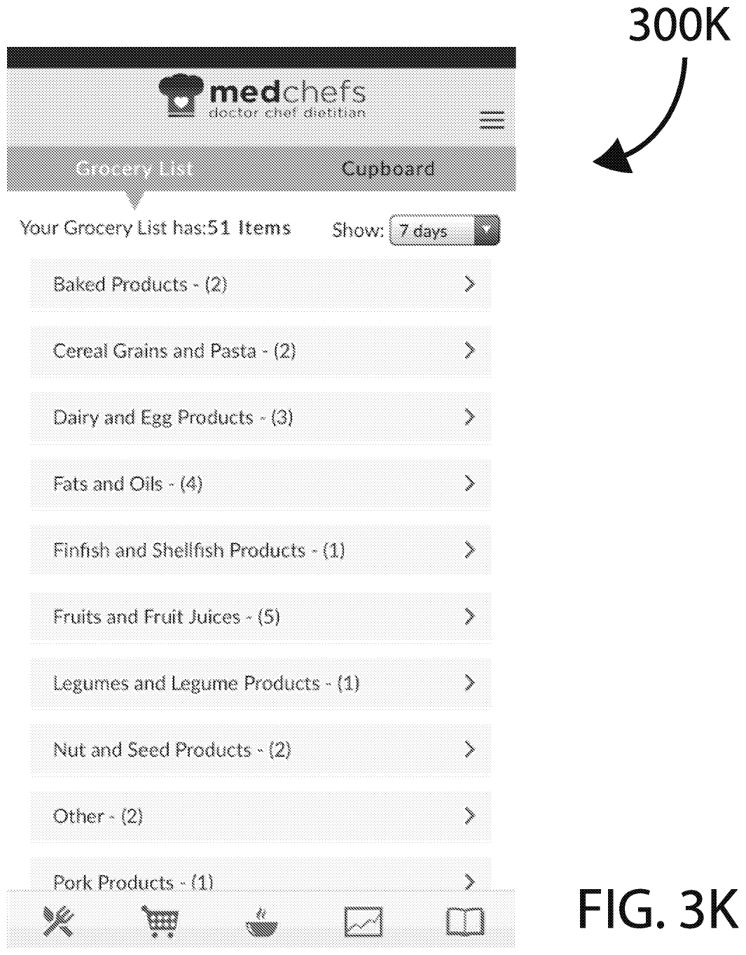

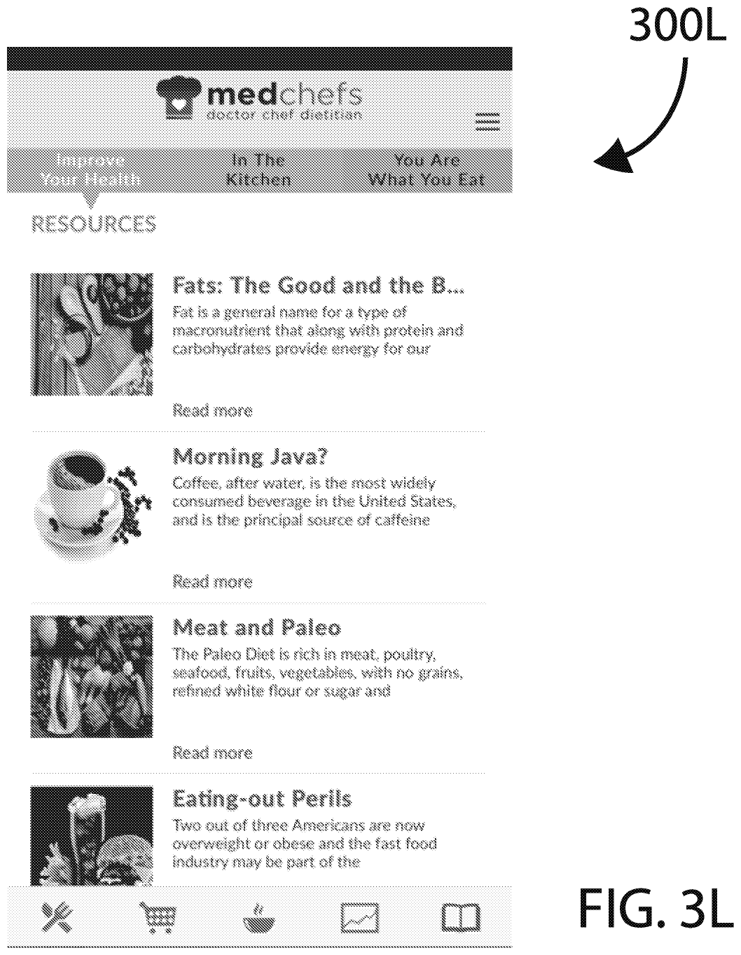

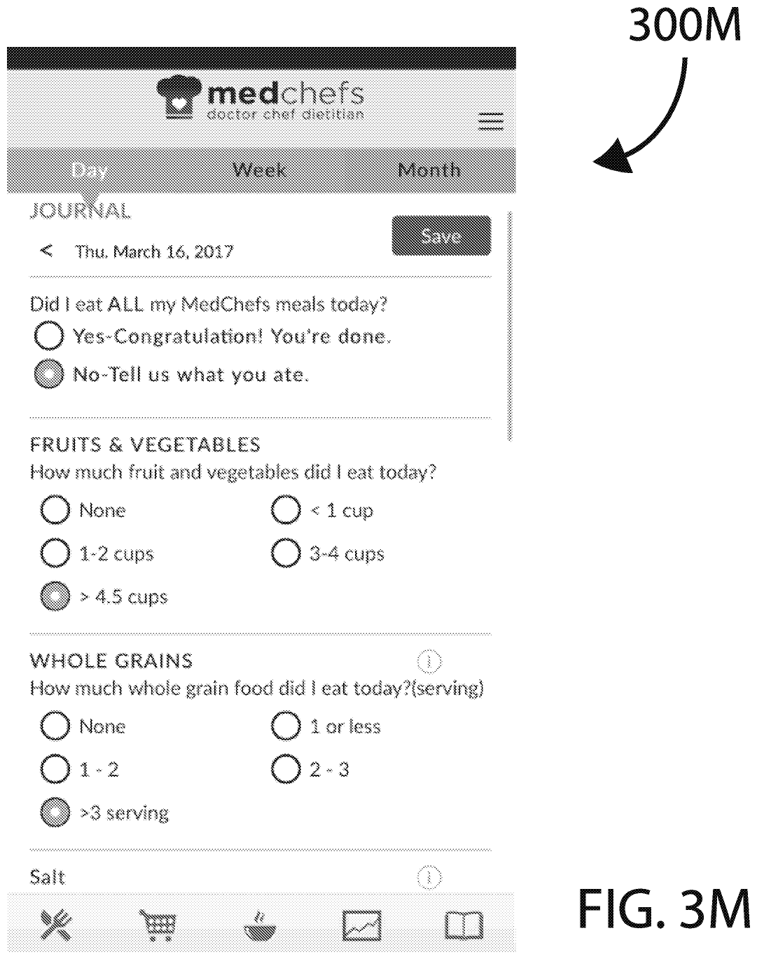

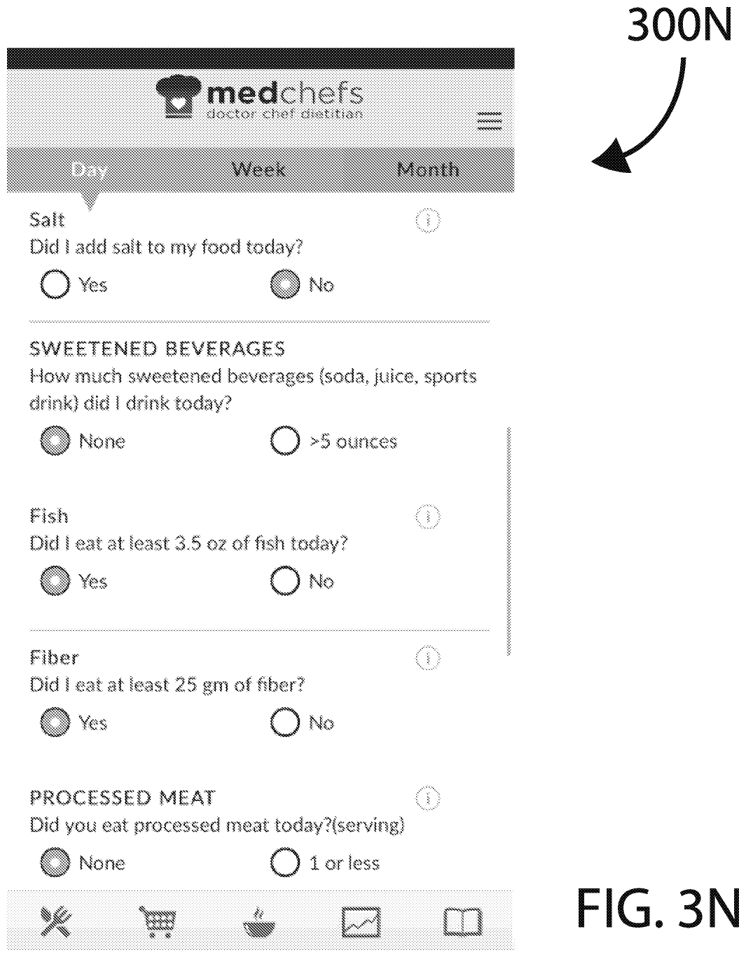

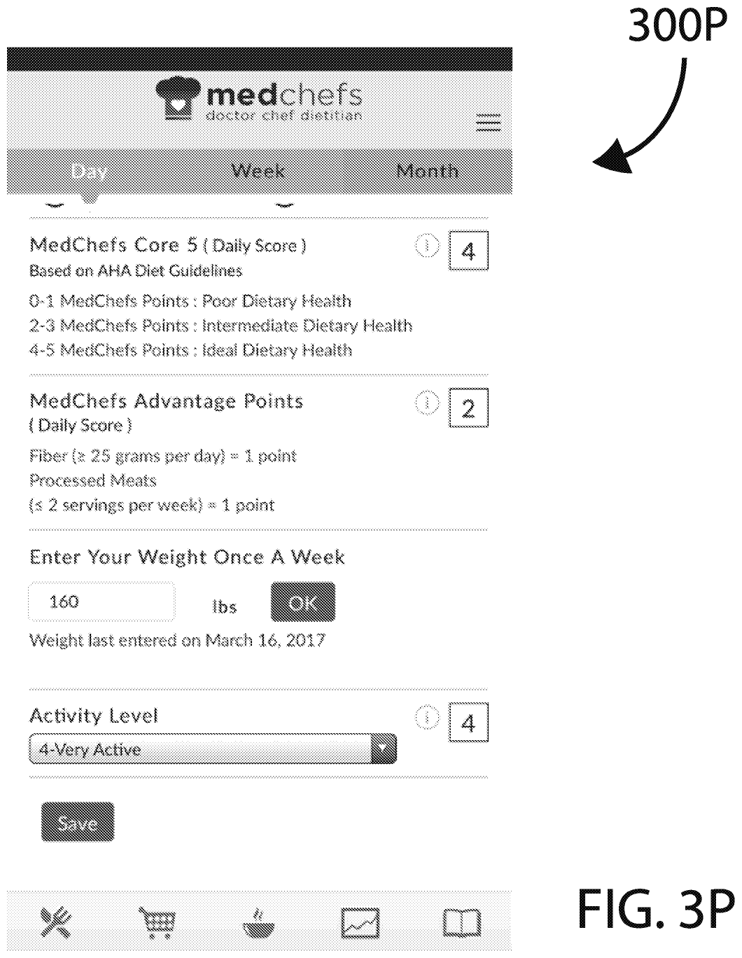

The flow diagram of FIG. 2 and the screenshots 300A-300H, 300J-300N and 300P of FIGS. 3A-3H, 3J-3N and 3P, illustrate the functionality of MedChefs Ecosystem 100, and more specifically the user interfaces of MedChefs Server(s) 150, accessible by beneficiaries and/or facilitators via one or more of Communicators 111-119 and 191-199, respectively. Screenshot 300A of FIG. 3A shows an exemplary home page suitable for display to a nutritional beneficiary (not shown) and/or the beneficiary's caregiver on a smart phone 111 or a tablet 112.

Referring to screenshot 300B of FIG. 3B, the beneficiary/caregiver can inputs the beneficiary's personal profile and lifestyle data, including age, gender, height, weight, body mass index (BMI), activity level, and smoking status (see steps 210 and 240). Other potentially useful, objective and pertinent personal information may include DNA profile (e.g., nucleal and mitochondrial DNA), ethnicity, and/or ancestry.

Awareness of the geographic location and/or climate of the metabolomic beneficiary may also be helpful. For example, the difference of the number of sunny days at various latitudes in combination with altitudes and weather affects one's ability to generate Vitamin D via skin exposure to sunlight. Each beneficiary's unique lifestyle can also affect her/his ability to generate Vitamin D, For example, one who hikes, jogs or swims outdoors will be exposed to more natural sunlight.

In most countries, location can be derived from a postal code such as ZIP code in the U.S.A. or the cell phone GPS signal. Awareness of the beneficiary's locality can also enable MedChefs Ecosystem 100 to optimize for overall freshness and/or cost of the metabolomic recommendation, by taking into consideration seasonality and/or availability of the food ingredients.

As shown in step 230, the MedChefs Server(s) 150 can also be configured to receive the beneficiary's pertinent medical condition(s) such as hypertensive disorder, insulin resistance, diabetes, lipid disorder, thyroid disorder, adrenal disorder, and autoimmune disorder, including risk factors of such condition(s). Other pertinent personal information received by MedChefs Server(s) 150 can include past and current treatment of medical condition(s) such as cancers therapies and procedures.

Using these personalized characteristics, the MedChefs Server(s) 150 can now compute a healthy combination of macronutrients and micronutrients customized for each metabolomic beneficiary. In other words, a proper balance of macronutrients and micronutrients is vital in maintaining health of every metabolomic beneficiary. The MedChefs Ecosystem 100 serves as a tool for adjusting macronutrient and micronutrient consumption to address unique health care requirements. This novel strategy is in stark contrast with known simplistic one-size-fits-all diet programs emphasizing caloric intake.

Hence, in accordance with various embodiments of the present invention, these individualized metabolomic regiments provide each metabolomic beneficiary with recommendations focused on the consumption of healthy foods preferred by the individual metabolomic beneficiary. Portion control is indirectly accomplished through the highly personalized recommendations and education.

Macronutrients include carbohydrates (both natural and processed), proteins (including essential amino acids), fats (including cholesterol and lipids), and fiber. Generally, carbohydrates can be found in grains and grain-based products such as pasta, pastry and breads, while proteins and fats can be found in meats and seafood. Fiber can be found in fruits and vegetables. Note that although plants include protein, vegetarian diets should carefully balance plant consumption to assure a proper mix of amino acids. Using this strategy, the MedChefs Ecosystem 100 can also be beneficial to vegetarians and/or vegans.

Micronutrients include vitamins, minerals, trace elements, amino acids and other organic compounds such as folic acid, carotenoids and antioxidants. For example, vitamins A, B1, B2, B3, B4, B5, B6, B7, B12, C, D, E and K, iron, calcium, iodine, fluoride,

Recommendations to the metabolomic beneficiaries can also take into consideration, for example, W.H.O. guidelines for healthy range of sugar consumption, and avoidance of unhealthy foods such as foods containing trans-unsaturated fatty acids; genetically-modified and/or highly processed food with preservatives commonly found in cured meats and packaged snacks such as potato chips.

In accordance with the present invention, various embodiments of MedChefs Ecosystem 100 can be tuned to one or more goals, primary, primordial prevention and/or secondary prevention for the metabolomic beneficiaries.

Primordial prevention: the prevention of the emergence of Risk Factors in a healthy population. For example: dietary services could prevent the development of hypertension or diabetes.

Primary prevention: the prevention of emergence of Disease in those that may be at risk. For example: preventing stroke or myocardial infarction by consuming proper dietary pattern in those with risk factors such as hypertension.

Secondary prevention: the prevention of Subsequent or Recurrent Events in those already with a defined disease process. For example, for those that have suffered a myocardial infarction (heart attack) a proper dietary pattern can prevent a second heart attack.

Hence, with the primordial/primary prevention goals in mind, for example, metabolomic protocols such as one based on a Mediterranean Dietary Pattern provides optimal population-based health outcomes for metabolomic beneficiaries. This exemplary metabolomic protocol includes:
>4.5 cups of fruits and vegetables per day;
>3 servings of whole grains per day;
at least 2 servings of fish per week;
<1,500 mg of sodium per day;
<36 ounces of sweet beverages per week;
<2 servings per week of processed meats; and
>25 grams of dietary fiber for women, >38 grams of dietary fiber for men.

Such metabolomic protocols provide the requisite macro and micronutrients for optimum health for primordial and primary prevention. Accordingly, in certain subsets for primary and secondary prevention, healthcare providers may find the MedChefs Ecosystem 100 very useful as a tool for “dialing in” more precise macro or micronutrient manipulation to address unique healthcare needs of the individual beneficiary metabolomic.

Using this flexible and multifaceted approach, MedChefs Ecosystem 100 is able to service a very wide range of metabolomic beneficiaries, each beneficiary with a unique profile and/or circumstance(s). In addition, adjustments can be made for individual conditions or circumstances of the individual metabolomic beneficiaries, including but not limited to pregnancy, recovery from illness, injury, surgery or medical chronic conditions such as diabetes, osteoporosis and/or hypertension.

In one example, Beneficiary A is 36-year-old healthy female Professor of Pharmacology. She weighs 135 pounds and is 5′ 6″ in height. Her BMI is 22. She practices yoga three times a week at the campus gym, and jogs the equivalent of three miles twice a week on an elliptical treadmill. She is three months pregnant. She is mildly allergic to peanuts and grass pollen. She is lactose intolerant. Her ancestry is 50% Native American and 50% Korean. Her paternal grandfather was diagnosed with type 2 diabetes at age 50. She works lives in the greater Boston area and shops for most of her groceries at Wholefoods™, Costco™, Trader Joes™ and Blue Apron™. Most days, she prefers to bring her own lunch so she has time to work on her novel. She eats out every Saturday evening at a local Italian or Japanese restaurant with her family.

In another diverse example, Beneficiary B is a 62-year-old male retired fire captain who lives with his wife in Anchorage, Ak. where they grew up. He weighs 195 pounds and is 6′ 1″ in height. He meditates five times a week, and hikes a couple of time a week weather permitting. He loves fishing and smokes his own salmon. He is allergic to penicillin. His ancestry is 50% Irish and 50% Italian. His maternal grandmother had a mild stroke at age 64. Both of his parents are in their 90s and they reside at a local assisted care facility. Two years ago, he was diagnosed with Stage 2 Non-Hodgkin Lymphoma and is currently responding well to monthly immunotherapy as an outpatient at a teaching hospital. He has moderate hypertension with a BP of 140/90 and a resting pulse rate of 75. They shop at a local Safeway™ and eat out at a steakhouse twice a week. They both love gardening and enjoy growing organic vegetables in their climate-controlled greenhouse.

In screenshots 300C-300F of FIGS. 3C-3F, the beneficiary/caregiver can continue by inputting the beneficiary's nutritional preference(s) and/or habit(s) (see step 220). Examples of preferences include meats such as beef and poultry, fish such as salmon and tuna, dairy such as cheese and yogurt, and vegetables such as broccoli and cabbage. Beneficiary preferences may also include dietary classifications such as gluten-free, vegan and vegetarian, and/or religious preferences such Kosher and Halal. Beneficiary dietary habits can include higher level choices of general food sources such as meats versus seafood, or number of meals per day and size of each serving. The profile of the beneficiary can be supplemented by medical condition(s) such as allergies to both food types and/or drugs, as exemplified in screenshot 300F.

By compiling and taking into consideration the beneficiary's profile, lifestyle, nutritional preference(s) and/or habit(s), MedChefs Server(s) 150 can now provide an easy-to-comply customized and yet dynamic nutritional plan for the beneficiary while providing the macronutrients and micronutrients (see screenshots 300G of FIG. 3G and step 250).

Beneficiary options for formulations of nutritional plans may range general recommendations to very specific meals, e.g., dinner comprising of three ounces of baked fish, five ounces of steamed broccoli, half cup of steamed brown rice, three ounces of dry-roasted unsalted cashews and one fresh navel orange.

In this exemplary dinner:
three ounces of baked salmon provides macronutrients 24 grams of protein, 10 grams of fat, and micronutrients 4% of daily vitamin A daily requirements, 4% of vitamin C daily requirements, and 2% of calcium daily requirements;
five ounces of steamed broccoli provides 0.64 gram of fat, 11 grams of carbohydrates, 5.2 grams of dietary fiber, 13% of vitamin A daily requirements, 135% of vitamin C daily requirements, 245% of vitamin K daily dietary requirements, 42% of folate daily dietary requirements;
half cup of steamed brown rice provides 0.8 gram of fat, 22 grams of carbohydrates, 1.7 grams of dietary fiber, 0% of vitamin A daily requirements, 0% of vitamin C daily requirements, 1% of vitamin K daily dietary requirements, 2% of folate daily dietary requirements;
three ounces of dry-roasted unsalted cashews provides 46 gram of fat, 30 grams of carbohydrates, 3.2 grams of dietary fiber, 0% of vitamin A daily requirements, 0% of vitamin C daily requirements, 42% of vitamin K daily dietary requirements, 6% of folate daily dietary requirements; and
one fresh navel orange provides 0.2 gram of fat, 21 grams of carbohydrates, 4.3 grams of dietary fiber, 8% of vitamin A daily requirements, 160% of vitamin C daily requirements, 0% of vitamin K daily dietary requirements, 14% of folate daily dietary requirements.

An objective score for the nutritional plan can be displayed thereby providing positive motivation to the beneficiary (see screenshot 300H illustrating an exemplary NutriTracker feature as shown in FIG. 3H). In this example, servings of fruits and vegetables, whole grains, salt, sugar and fish are tracked.

As illustrated by screenshots 300J-300K of FIGS. 3J-3K, in some embodiments, the MedChefs Server(s) 150 can also provide helpful recipe(s) and grocery list(s), respectively. The grocery list may also be categorized into food categories/types for ease of nutritional tracking, including but not limited to macronutrient categories. The grocery list can be divided into Food Group categories for shopping convenience, and further broken down into specific groups such as baked products, cereal grains and pasta, daily and egg products, fats and oils, finfish and shellfish, fruits, legumes, nuts and meats. Note that food can be packaged and preserved in many forms, including fresh, chilled, frozen, freeze-dried, smoked, canned, or bottled.

Nutritional resources such as helpful nutritional information may also be provided to the nutritional beneficiaries and/or caregivers in the form of studies written for the lay population and based on real science, as exemplified by screenshot 300L of FIG. 3L. To protect beneficiaries from potential harmful misinformation, the MedChefs Server(s) 150 screens and vet article(s) based on anecdotal evidence prior to dissemination.

In steps 260 & 270, the nutritional plan for the beneficiary can be periodically adjusted in response to compliance feedback for example, by compiling a journal which includes the beneficiary's intake of sodium, sweetened beverages, fish, and fiber (see screenshots 300M-300N of FIGS. 3M-3N).

Screenshot 300P of FIG. 3P illustrates the capability to substantially improve beneficiary compliance to the nutritional plan by providing reinforcing positive feedback in the form of exemplary NutriTracker's MedChefs Core5 Scores based on MedChefs Advantage Points. Additional forms of positive reinforcement can include financial incentives such as reward points redeemable at facilitators such as grocery stores.

The MedChefs recommendations are generally based on well-researched science such the American Heart Association (AHA) Dietary Guideline and AHA dietary score. In one embodiment, NutriTracker of MedChefs Ecosystem 100 awards the metabolomic beneficiary with Core 5 and/or Advantage Points as follows:
1 Point for >4.5 cups of fruits and vegetables per day;
1 Point for >3 servings of whole grains per day;
1 Point for at least 2 servings of fish per week;
1 Point for <1,500 mg of sodium per day;
1 Point for <36 ounces of sweet beverages per week;
1 Point for <2 servings per week of processed meats; and
1 Point for >25 grams of dietary fiber for women, or >38 grams of dietary fiber for men.

In some embodiments, user interfaces of MedChefs Server(s) 150 are configured to accommodate sales/marketing information, e.g., paid advertisements with or without embedded web links, originating from MedChefs Server(s) 150 and/or Third party Server(s) 170. Such sales/marketing information can potentially generate revenue for supporting the operations of MedChefs Server(s) 150.

Many other modifications and additions to the above described embodiments are possible. For example, recommendations can include recipes that promote health while suggesting spices or seasonings such as turmeric, ginger, onions, lemon and garlic to enhance flavors preferred by the metabolomic beneficiary while substituting and/or minimizing potentially harmful additives such as salt and sugars and stimulants such as caffeine.

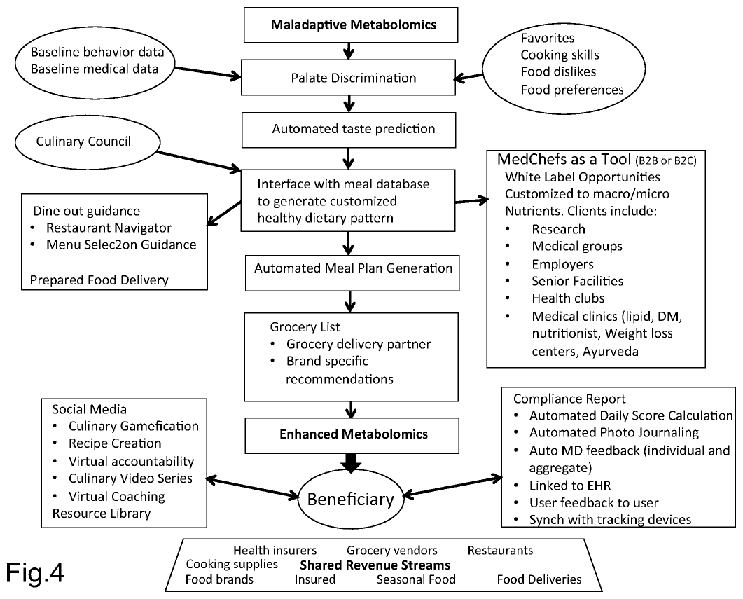

MedChefs Servers 150 can also be operatively coupled to partners via Third Party Servers 170. Partnerships include any entity with financial risk for the health of a population. In other words any stakeholder including medical groups and hospitals, employers, public health services, and insurance companies. As illustrated by FIG. 4, potential partners can also include grocery stores, health clubs, senior facilities, medical groups, and hospitals.

Additional possible MedChefs auxiliary partners may include pet food stores to save on delivery costs. Other auxiliary partners can include dog walking services, janitorial services, chauffeur services, gardening/landscaping services (enabling organic farming at home), emergency food suppliers, restaurants, hotels, farmers markets, delivery services, airlines (especially international carriers), book-a-chef services, caterers, trains, cruise lines, ferries, buses, limo services, ride sharing services, and self-driving vehicular services.

MedChefs Ecosystem 100 may also encompass partnerships with online social networks such as FaceBook™. One exemplary use of social networking partnerships is to enable friends/family of a recuperating, ailing or grieving beneficiary to coordinate food drops for the beneficiary and/or her/his immediate family member(s), especially if they are minors or disabled.

As such, potential partners include any potential direct and indirect revenue generators, for example, amateur and professional athletic organizations seeking to optimize athletic performance by using the MedChefs Ecosystem 100 to “dial in” precise event-specific nutritional requirements. Other potential partnerships can also include non-profit, governmental and quasi-governmental organizations, such Red Cross™, Red Crescent™, State Office of Emergency Services, and FEMA.

It is also contemplated that MedChefs Ecosystem 100 will serve a very wide range of beneficiaries. For active beneficiaries, MedChefs Ecosystem 100 can partner with operators/guides of campsites, backpackers, cross country skiers, mountain climbers, to for example provide high-calorie freeze-fried foods. MedChefs Ecosystem 100 can also serve patients with chronic and/or physiological conditions such as eating disorders (e.g., bulimia and anorexia).

Since MedChefs Ecosystem 100 has the ability for highly personalized interaction with individual metabolomic beneficiaries and/or their caregivers, it may also be possible to for Ecosystem 100 to support clinical studies that include food as a component.

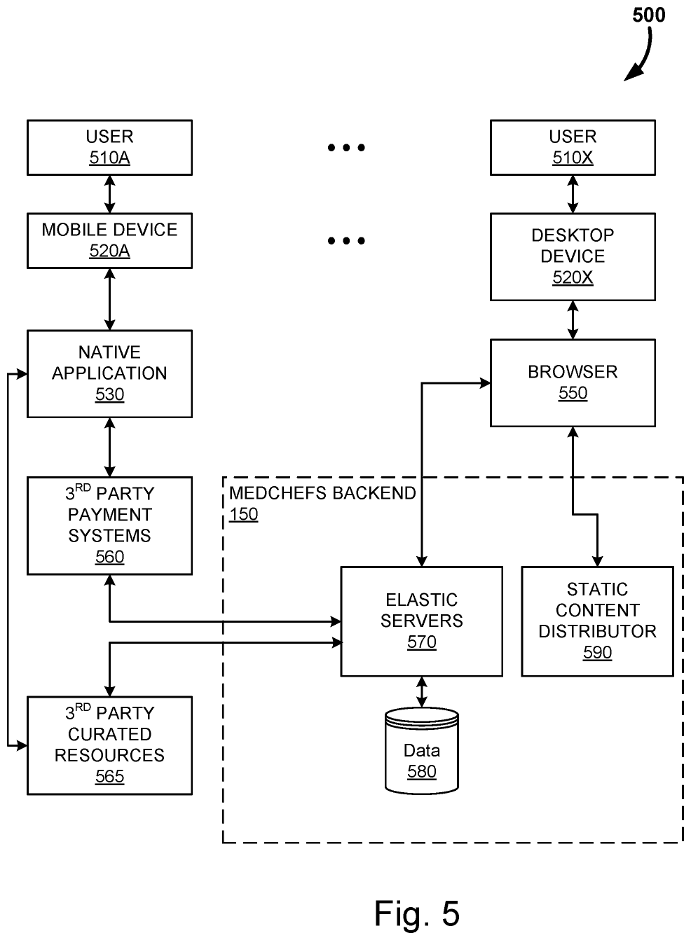

Turning now to FIG. 5, more specific embodiments of the MedChefs ecosystem are provided, generally at 500. As with the prior illustrations, a plurality of nutritional beneficiaries (also referred to as users or individuals) 510a-x are illustrated interacting with the system. These user's 510a-x interact with the system through a myriad of devices 520a-x. In some cases these devices are mobile devices (as seen at device 520a). In other situations the devices are desktop/laptop devices (as seen at device 520x).

A native application 530 is utilized by the mobile device(s) 520a to access the backend systems. This native application is downloaded from an app or play store onto the mobile device 520a. The native application leverages a network (not illustrated) to access the Medchefs server infrastructure 150. Generally, this network comprises the internet, and often a cellular network. The network may include any local area network, wide area network, corporate infrastructure, and the like as well. The native application may interface with third party payment systems 560 to manage the payments/subscriptions required for the access of the MedChefs services.

In contrast, the desktop device(s) 520x may access the backend system via a browser 550. Much of the browser content is static, and as such a static content distributor 590 may be employed to quickly load the content from geographically distributed content servers to the given browser 550. Regardless of the device employed, or whether a browser or native application is being leveraged, the users 510a-x are able to access the MedChefs backend system 150. The backend system includes one or more elastic servers 570 for the actual hosting and content distribution to the devices 520a-x. The elastic servers 570 have access to datastores 580 as well as external 3^{rd} party resources 565, which have been curated for distribution to the users 510a-x.

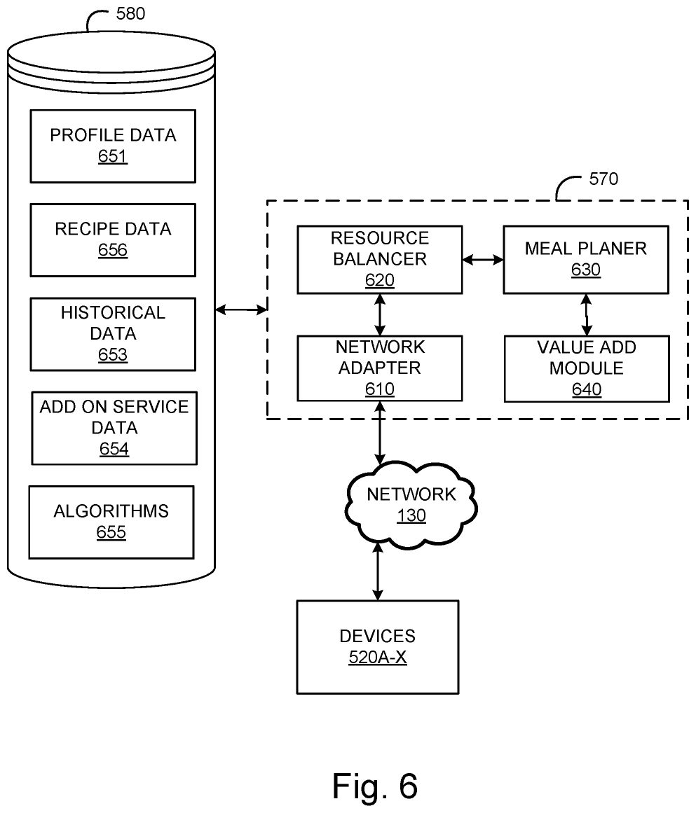

FIG. 6 provides more detail around the elastic servers 570. In some embodiments, the elastic servers 570 may include a plurality of virtual machines located on one or more server systems. In some cases, the elastic servers 570 scale as system loads change. The devices access the elastic servers 570 via the network 130 through a network adapter 610. A resource balancer 620 scales the number/level of resources made available for processing. This may include spooling up additional servers as loads increase, and reducing server resources as loads decrease. The resource balancer 620 may also ensure that each of the server resources is under the same or similar workloads to ensure the best system operation. The heart of the elastic servers 570 is the meal planner module 630. The meal planner 630 generates the actual meal plans for the various users 510a-x. This module consumes each user's dietary requirements, nutritional needs (based upon at least some of age, gender, weight, height, activity levels, BMI, pathology, disposition to a pathology, and the like), and palate preferences to generate a suitable meal plan that meets all macronutritional and micronutritional requirements, and responsive to each of these factors. This meal planning process has been previously described, and shall be described in further detail below. The meal planner may also include sophisticated reporting and statistical analysis functionalities.

A value add module 640 provides additional services to the user 510 based upon the user's unique situation. This may include delivery services, ‘shopping list’ generation, premade meal options, restaurant services, and the like. The value add module 640 may also provide the user 510 additional curated resources and other information.

The elastic servers 570 may rely upon the data stores 580 for the generation of the meal plans and the delivery of the value added services. The data store may include user profile data 651, recipe data 656, historical data 653, add on service data 654 and algorithms 655 for the meal generation. Specifics of meal plan generation, and value add service delivery using these data elements will be described in greater detail in the following sections.

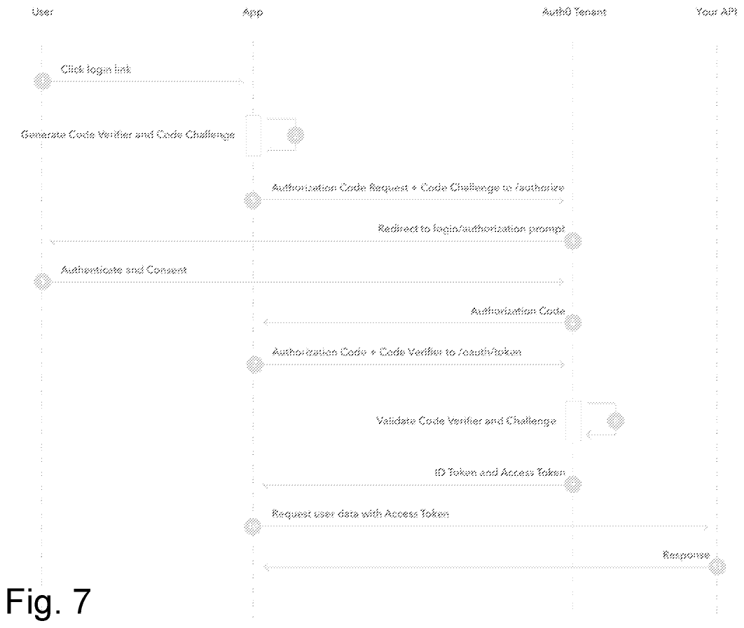

FIG. 7 provides a swim lane diagram for the process of user authentication into the system. Initially the user can select a login link (at step 1). The application generates a code verifier and code challenge (at step 2). An authorization code request and code challenge is sent to the authentication tenant (at step 3).

The user is then redirected to an authentication prompt (at step 4). The user authenticates and consents to the terms of use for the application (at step 5). An authentication code is provided from the authentication tenant to the application (at step 6). From the application a authentication code and code verifier is provided back to the authentication tenant (at step 7. At the authentication tenant, the code verifier is validated (at step 8). An identification token and access token are provided back to the application (at step 9). Lastly, user data is requested from the API (at step 10) using an access token, and a response is received (at step 11).

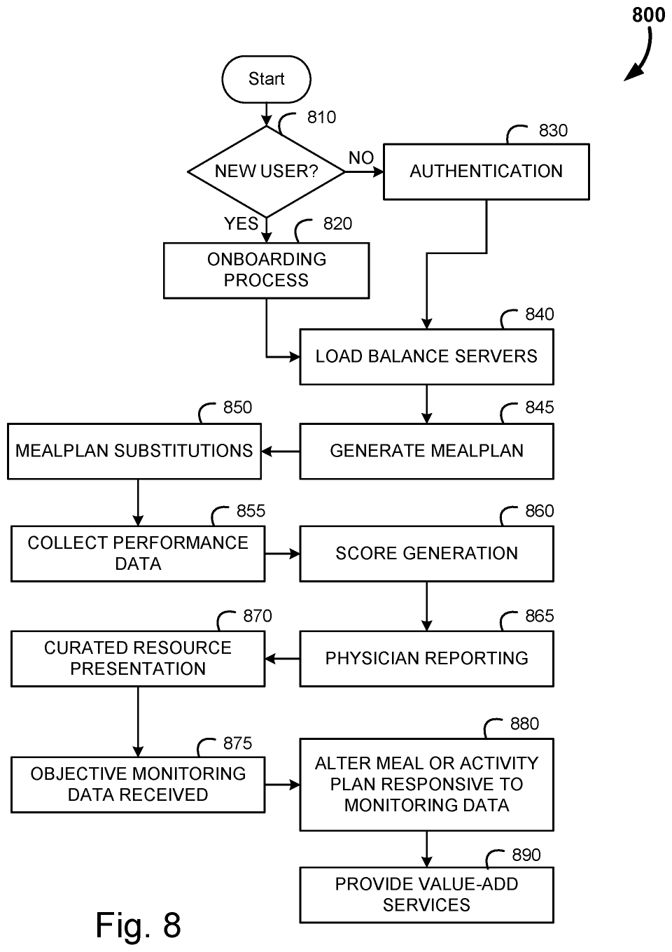

Attention will now be turned to the flow diagram of FIG. 8, shown generally at 800, which describes the functioning of the MedChefs system. The process starts with the determination if the user is new or not (at 810). If the user is new, the user is redirected to an onboarding process (at 820). The onboarding process generally involves the downloading of an application (when leveraging a mobile device for access), or the access of an application via a we browser. The user is then required to set up a user account, including the generation of a username/password pair, and generally the ability to perform a two-step authentication. The user is then required to populate a profile. The degree of profile population may be optional and varied in some embodiments. For example, in some cases the user may only indicate their age and gender. However, in alternate embodiments, it may be desirable to have additional information for the user to more finely tune the meal planning process.

For example, at another level of detail, the user may at a minimum provide information regarding dietary restrictions (allergies or other self-imposed diet conditions), as well as palate preferences. At another level of granularity, the user may upload information relating to their weight, height, physiology information (e.g., cholesterol, blood pressure, etc.), pathologies (if present), and predispositions to pathologies or familial histories. The user may likewise be able to synchronize smart devices for additional data sources. For example, a smart watch, smart scale, smart exercise equipment, Fitbit or similar activity tracker device, smart fridge (and other appliances) and the like may all be linked to the user's account). Generally, the more data rich the user's profile becomes, the more tailored the meal planning may be, dependent upon the embodiment.

If the user is a returning user, all this profile information is already present and stored within the backend system. As such, upon accessing the system, the user merely needs to be authenticated (at 830), as described in the previous FIG. 7. Regardless of whether the user is generating a new account or merely being authenticated, a determination is made on the level of resources that are currently on the system, and if additional resources need to be requisitioned or not. As noted before, the elastic server stack may be comprised of many server resources that may dynamically be spooled up or down based upon demand. Additionally, for the given resources present, the system may balance loads across the various server resources in order to maximize system performance (at 840).

After access of the backend system is completed, the system may generate a meal plan for the user (at 845). Meal plan generation may be as simple or as complex as desired. For example, when the available data for the user is extremely limited, a general meal plan that meets all required macronutritional and micronutritional requirements as set out by organizations such as the AHA may be employed (as previously discussed in considerable detail). However, in some embodiments, the system may scale in complexity based upon data available.

For example, each data point may alter the micronutritional and macronutritional requirements for the individual. For example, a woman requires a higher level of iron as compared to a man. An individual with a higher BMI may require a lower caloric intake than someone with a healthy BMI. An active individual may require slightly higher caloric intake. An individual in Seattle may require a greater amount of vitamin D as compared against an individual in Southern California. An elderly individual may require more calcium, but lower caloric intake and vitamin B12 than a younger individual. A pre-diabetic individual may require lower carbohydrate intake as compared against a non-pre-diabetic individual. An individual with cardiopulmonary disease may require a particular level and ration of HDL and LDL cholesterol.

Each datapoint for the user may be used to alter the required nutritional profile away from a ‘standard’ profile. As the profile is richer, the more finely tuned the nutritional profile may be, in some embodiments. The next step is to generate a ‘base’ meal plan for the desired nutritional profile. This base meal plan leverages sets of different recipes to generate the micro and macro nutritional profile that most closely matches the needs of the user. This selection may be subject to various constraints, such as only certain recipes being considered for given meals (a fruit parfait may be limited to a breakfast or lunch for example), and the limit to the number of particular ‘types’ of recipes at any given meal (only one meat for dinner for example). A multivariate equation may be leveraged to generate the selection of recipes that most closely meet the nutritional profile. Clustering algorithms and distance algorithms (K-means square or best fit curves) may be employed to determine what nutritional profiles are a ‘best fit’.

In some embodiments, the nutritional requirements for the user may even be weighted where certain nutritional elements are considered more important than others when determining the best fit between the base meal plan and the nutritional profile. For example, a diabetic elderly woman may need a higher level of calcium, and a minimization of carbohydrates. The increased calcium is important for staving off osteoporosis, however the carbohydrate intake has immediate and significant ramifications for the individual's health due to her underlying pathology. As such, the carbohydrate requirement may be afforded a larger numerical weight than the calcium intake, and when determining what meal plan ‘fits’ her the best, the reduced carbohydrate diet may be deemed a better fit, even if the calcium intake is sub-optimal.

In some embodiments, the degree of personalization for the base meal plan may be less complex, and a more generalized micro and macro nutritional profile is leveraged across a larger segment of the user base. In some embodiments, the profile may be defined by an external trusted source, such as the AHA, AMA or similar organizations. The advantage of leveraging a more generalized nutritional profile is that there is a significant reduction in processing requirements, and the generation of ‘odd’ meal plans is reduced.

After the base meal plan has been determined (regardless of methodology employed for its generation), a series of substitutions may be employed to meet the user's dietary requirements and palate preferences (at 850). In this step, it is determined which ingredients are in conflict with a dietary requirement first. For example, a user may be lactose intolerant, and a recipe may call for milk as an ingredient. A determination may be made by the system if a simple ingredient substitution is possible, or if the entire dish needs to be replaced. In some embodiments, the system may include a series of acceptable substitutions (e.g., olive oil for butter, coconut milk for cream for meat dishes, lemon juice for malted vinegar, etc.). In some embodiments a set of substitution rules may be employed for all recipes (e.g., any recipe may substitute olive oil for butter), in other embodiments, only particular ingredients in a given recipe may be substitutable. In these embodiments, the recipes in the data store may be flagged with indicators that note when an ingredient may be interchanged, and what the substitution is allowed to be. For example, in a fish dish, the recipe may call for a fillet of salmon, however the fish may be substitutable with any white fish, and the butter may be substituted with olive oil. In contrast, a pancake recipe may not allow for substitution of the butter with olive oil.

In other cases, a simple ingredient substitution may be disallowed completely (or simply not be practical). In these situations, the substitutions may be applied for the entire meal element. For example, an omelet dish would not allow for a simple ingredient substitution if the individual is allergic to eggs. In these situations, the entire dish may be substituted with another compliant dish that has a similar nutritional profile.

A similar substitution process may be performed based upon palate preferences as well. These substitutions, while not technically needed, ensure that the compliance to the diet is improved. Palate preferences may be inputted by the user directly into the application, learned over time by the system, or a combination of the two. For example, the user may input that they do not like spinach. The system then substitutes a broccoli dish for the spinach, however, the user's compliance to this dish is likewise poor. The system may employ learning algorithms to identify such patterns, and in some embodiments, engage in a testing protocol. This testing may include randomizing foods with similar nutritional profiles over time. Increased compliance with the diet may indicate that the user enjoys eating particular foods more then others. This feedback data may be employed to refine the palate preferences beyond what has been supplied by the user directly. In some embodiments, rather than having a strict determination that a user does or does not enjoy a particular dish/ingredient, a sliding scale for the palate preferences of the user may be employed. For example, a user may eat blueberries on occasion, but really enjoys eating strawberries far more often. This gradient of preference may be employed when determining the frequency that a particular food in incorporated into the meal plan.

Another factor used to determine recipe substitution is the cooking skill level of the individual. Generally, the system attempts to leverage recipes that have been curated for their relative ease of preparation. People have limited time, and easy meals are generally adhered to better than complex meals. However, if the user indicates that they possess advanced cooking skills, and shows a proclivity for making more elaborate meals, then the system may adapt in its initial meal plan, and/or in the substitutions made, to incorporate more complex meals. In some embodiments, these complex meals may be preferentially scheduled for weekend evenings to more readily match the user's schedule.

It should be noted that the processes described above would become monotonous over time to a user, as a dietary plan that is strictly optimized in this manner would be the same every time. As such, the system may employ a randomization (or pseudo randomization) when determining the meal plan. This allows for the user to be exposed to a variety of dishes rather than repeated meals.

In some additional embodiments, the meal planning may be an iterative process. After the substitutions are performed, a re-analysis of the nutritional profile against the desired profile may be performed. For example, an individual who is lactose intolerant may have a large portion of their calcium intake removed as a result of the substitutions. As such the system may re-optimize the meal plan to include a spinach dish (spinach is a high source of calcium). The process may then repeat with substitutions and re-optimizations until a final meal plan is reached.

In some embodiments, rather than a nutritional profile matching/optimization process, one or more curated meal plans may be employed for segments (or all) users. These curated meal plans are designed to meet the nutritional requirements of the individuals, and ‘fit’ well together from a palate perspective. Substitutions, as described above, may then be employed to cater the meal plan to the individual.

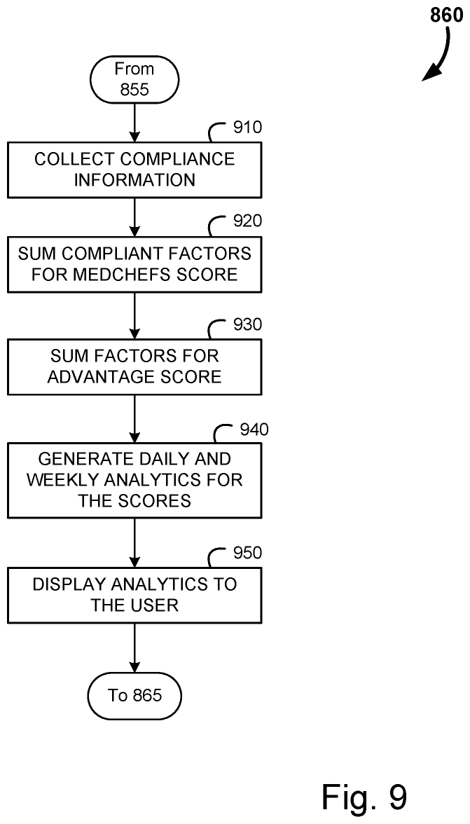

After meal plan generation with substitutions has been performed, the meal plan and attendant recipes is presented to the user. The user then either complies with, or ‘cheats’ and does not comply with the meal plan. The user is asked about her compliance with the meal plan, and performance/compliance data is collected (at 855). Using this data a set of scores may be generated for the user (at 860). FIG. 9 provides a more detailed description of this score generation process. Initially compliance information is collected (at 910) as noted above. Compliance information includes determining what portions of the meal plan were followed, in some embodiment. In another embodiment, compliance information includes not only what was not adhered to, but also items consumed that were not part of the scheduled meal plan.

The compliant factors (and sometimes the non-prescribed foods eaten) may be compiled into a MedChefs score (at 920). In some embodiments, the MedChefs score is a simple five-point scale score that is based upon the user consuming a requisite amount of fruits and vegetables, legumes, fish, salt and sweetened beverages. In other embodiments, the MedChefs score may be a ten-point scale. In some particular embodiments, the ten point scale may include a point for greater than 4.5 cups of fruit and/or vegetables per day, a point for greater than 1.5 cups of whole grains per day, a point for more than 0.5 cups of legumes per day, a point for greater than 25 grams of fiber per day for females and 35 for males, a point for less than 1500 mg sodium per day, a point for less than 5 oz. of sweetened beverages per day, a point for less than 5% of total calories consumed being added sugars per day, a point for 3.5 oz of oily fish consumed twice per week, a point for less than 3.5 oz of processed meats per week, and a point for at least 1.5 oz nuts or seeds consumed per day. In this ten-point scale, 8 or more points would indicate an ideal diet, 5-7 points would constitute and adequate diet, and less than 5 points would indicate a poor diet.

In some embodiments, the score is modified/scaled based upon the degree of calories over the recommended caloric intake for the individual. For example, a man that has three servings of vegetables and adheres to a 2000 calorie diet may be afforded a higher score than an individual who also had three servings of vegetables, and yet consumed 3000 calories that day.

In yet other embodiments, the score may be a composite of the above disclosed factors, but with each factor being afforded a different numerical weight. For example, it may be desirable to have both a serving of fish and three servings of vegetables a day; however, the vegetable intake may be weighted more heavily than the fish intake when computing the score.

The benefit of the above disclosed scores is that it is readily understood by the user, and thus provided a gamification element to the process. If the user knows that they get a point for eating a serving of fish, then the user is more likely to strive to eat fish. However, it may be desirable to generate additional metrics as well. These metrics may be individual percentages or scores for each macro and micro nutritional element in the diet for example. To an individual user, such data may be virtually meaningless, but such scores, when provided to a physician or other health care professional, may be extremely useful.

In addition to the generation of a MedChefs score, an advantage score on a weekly basis (whereas the MedChefs score may be computed on a daily basis) may be compiled (at 930). The advantage score may be computed per week, or on a rolling seven day schedule. The advantage score, in some embodiments, may consist of a two point score-the first point may be awarded for maintaining a consumption of processed meats below a set threshold, and the second point is awarded for a daily intake of fiber above a set threshold. These thresholds may be dynamic, and may differ based upon gender, age or another metric.

After the MedChefs score and advantage score (and any other scores) are compiled, analytics for these scores may be generated (at 940). Analytics may be generated on a daily basis, or averaged over a weekly (or longer) basis. These analytics are then presented to the user (at 950) in an easily digestible manner. This may include employing simple to read graphs and other informational diagrams. Examples of these analytics will be presented and discussed in greater detail below in relation to the attendant screenshots.

Returning to FIG. 8, after the scores have been generated, this data, as well as other curated data may be provided (at 865) to a physician (or other healthcare entity) for recording in the patient charts, active analysis, and when desired, modification of the meal plans by the physician directly. As noted before, more detailed analysis of the user's nutritional consumption may be provided to a physician than may be necessary (or desirable) to share with the user. Roll-ups of weekly nutritional consumption may be provided as a ratio of desired nutrient intake. In some embodiments these ratios may indicate what percentage of the desired nutrient level had been consumed. For water soluble nutrients, or nutrients where there is no significant upper limit, the ratio may be expressed as having a cap at 100%. For nutrients that ‘too much’ is unhealthy (e.g., calories, vitamin A, etc.) the ratio may extend beyond the 100% mark. In some embodiments, significant deviations from the required nutritional levels may be flagged for the physician (e.g., color coded, bolded or larger font, displayed first, etc.).

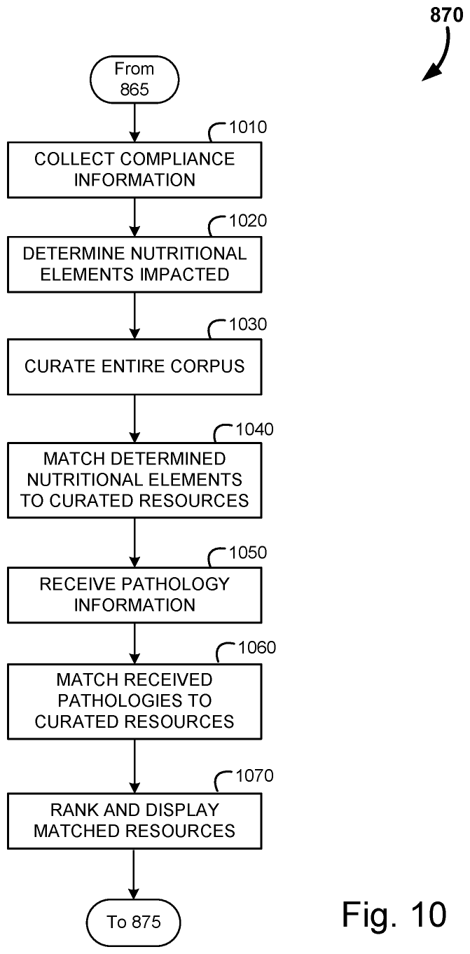

After the transmission of the nutrition data to the user's physician (when applicable), the process includes the curation of external (or internally derived) resources for presentation to the user (at 870). Resources may include video clips, articles and tools that are useful to the user. In some embodiments, a single curated corpus of resources may be made available to every user. In alternate embodiments, the resources presented to the user may be personalized to that individual. FIG. 10 provides a more detailed description for the process of personalizing the resources for a given user.

Again, this process starts with the collection of the compliance information (at 1010) by the user to the prescribed meal plan. The nutritional elements particularly impacted by the compliance (or lack thereof) are determined (at 1020). For example, if the user routinely misses meals that contain fish, then the element identified as being deficient may be ‘fish’. In other embodiments, specific nutrients may be identified as nutritional elements. If for some reason, the user misses a variety of foods over time, but this causes a dramatic reduction of calcium intake as compared to an ideal level, then the nutritional element identified may be ‘calcium’. Likewise, routine overeating may identify the element ‘calories’, etc.

An entire corpus of materials are then curated (at 1030). This may include tagging the various articles, videos and other resources with relevant flags. For example, an article on the health benefits of fish may be tagged with ‘fish’, ‘lean protein’, ‘HDL cholesterol’. The elements that were determined from the user's dietary compliance are then matched against these tags (at 1040).

Pathology information for the individual may also be collected (at 1050). The tags for the curated resources are likewise matched to the pathology (at 1060). For example, an individual suffering from obesity may be matched to the tag ‘weight loss’. All of these matched resources are then compiled and ranked for display to the user (at 1070). Ranking may be based upon importance of the tag, number of tags matching the user for a given resource, a set ranking for all resources by the curators, or by some other metric.

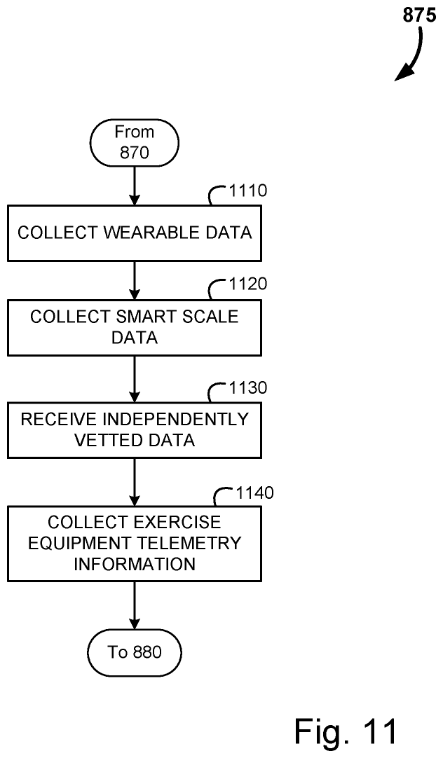

Returning to FIG. 8, after resource curation and display, the collection of objective monitoring data may occur (at 875). It is an unfortunate fact that many people are not entirely accurate when self-reporting on their dietary, exercise or health related activities. As such, the ability to collect corroborating evidence can help in ensuring that the data collected for an individual is as accurate as possible. FIG. 11 provides a more detailed example of the process for collecting objective data for the user.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. This data generally comes from wearable devices (at 1110), or other ‘smart’ household devices. The most commonly known wearable device includes Fitbits and similar smart watch and health tracking devices. Generally, these devices record activity levels, sleep patterns, pulse and blood oxygenation. It is assumed that over time additional telemetry data may be accessible from these devices as well. It should be noted, however, that wearable devices may include much more than smart watches and the like. For example, glucose monitors, pacemakers, blood pressure cuffs, and other devices that continually collect user data are all considered under the category of “wearable devices”.

Additional data may come from devices like smart scales (at 1120), and data collected by smart exercise equipment and the like (at 1130). Other data that is ‘objective’ may be received from independent sources (e.g., a physician, health coach, trainer, chef, etc.). Regardless of source, all of this independently collected data may be compiled into the user's profile for additional analytics.

Returning to FIG. 8, after objective data has been collected, the system, where applicable, may alter meal and/or activity programs responsive to the collected data (at 880). For example, if a user self-reports a certain level of activity, the meal planning system may allocate a higher or lower caloric requirement responsive to this data. If however, it is shown by the user's wearable device that they have over-reported their activity level, or a smart scale indicates an increase in BMI, the meal plan may be adjusted to compensate.

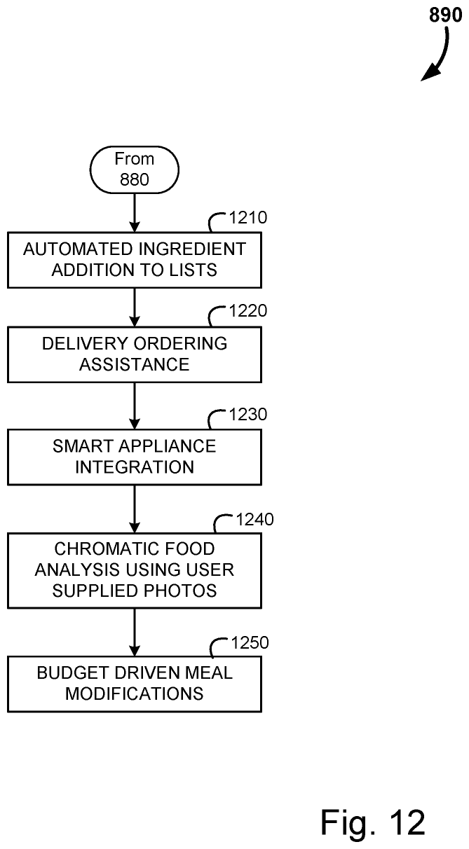

The last step in the process is the providing by the system of value-add services to the user (at 890). FIG. 12 provides a more detailed process for these value-add services. At a minimum the system may automate the process for building a shopping list for the user. This may include integrating applications for retailers with the system. For example, the supermarket retailer Kroger has an application that may be downloaded that allows shopping lists to be generated and tied to the user's loyalty program. If the MedChefs system is linked to this retailer application, the system may be able to populate the retailer application with a shopping list. Likewise, other retailer agnostic applications, such as Instacart, may be tied to the MedChefs application, allowing for a shopping list to be populated on these sorts of platforms.

In some embodiments, all ingredients used in the meal planning recipes are placed into these shopping lists. In other embodiments, the system may query the user for commonly owned ingredients. For example, it is highly unlikely that a user will require olive oil every time it is called for in a recipe, as a bottle of olive oil generally lasts for many meals. As such, for such ‘durable’ ingredients, the user may be queried before they are added to the shopping list.

In addition to list generation, the automated delivery of ingredients may be enabled through the application (at 1220). One significant advantage to the meal planning process is that the system knows well in advance what ingredients are needed by the user. If automated grocery delivery is enabled, the system may, on a configurable cadence (generally every three days), ensure the delivery of the needed ingredients for the upcoming meals. The system may track ingredient usage and needs, such that in our olive oil example, durable ingredients are only delivered when needed.

It is also possible that the system may integrate with smart appliances to further streamline the shopping list generation (at 1230). For example, if a smart fridge knows that the user already has milk, then this ingredient may be omitted from the shopping list generation or automated grocery delivery.

Another value-add service provided by the system is a chromatic food analyzer (at 1240). A diet rich in fruits and vegetables correlated with enhanced health. The guidance to “eat from the rainbow” is a surrogate measurement of a diet comprised of a disproportionate amount of fruits and vegetables. A color spectrum of the food consumed is an objective measurement of the “eating from the rainbow” concept. This plug-in application enables the user to take a picture of their meal, and the system identifies the colors of the meal within the image. The color spectrum, contrast and brightness are all used to approximate the nutritional value of the food. Diversity of colors increases the food score. The color spectrum will be assessed and segregated into two categories representing a threshold about of color (defined as green, red, blue, purple, orange and yellow) vs lack of color (brown and beige). Binary scoring will be based on the presence or absence of color. For plates representing the threshold amount of color the spectrum will be further analyzed with additional points awarded based on the variety of the color spectrum represented. This enhanced score will encourage not just a colorful plate representing fruits and vegetables but a variety of fruit and vegetables; yet, another marker for enhanced health. The ‘score’ generated by the chromatic analyzer may be integrated into the determination of the MedChefs score or may be a standalone score for the user's review.

Another value-add service is the sourcing of recipes and ingredients based upon non-dietary driven factors. The most common factor may include budgetary constraints (at 1250). In some embodiments, the user is able to input a desired budget, and the system may alter the recipes, much in the manner discussed above for other substitutions, in order to meet the budget. Generally the system will identify highest cost ingredients first, (such as a salmon fillet for example), and using information collected from individual retailers, or a retailer aggregation site such as Instacart, determine if there is substitutions available (for example tilapia rather than salmon). The system may also determine, in aggregate, which retailer provides the best price for the ingredients for the next three of so days. Each retailer undergoes different promotions and sales. Sometimes these sales may cause a significant difference in the price of ingredients. If the differential in pricing between retailers is minimal, however, this can be indicated to the user as well, so that the most convenient retailer may be chosen by the user. In some embodiments, budget sensitive users may select one or more retailers that she is willing to purchase from, and the system will generate multiple shopping lists for each of the retailers which meets the ingredient requirements, but optimizes the pricing for the user. In such systems, retailers that are determined to have only a couple items (e.g., a configurable threshold by the user, which may default to three items), the retailer will be omitted from the list of retailers that are shopped from, and the items rolled into other shopping lists for retailers that already have more items. In yet other embodiments, the user may also designate a maximum number of retailers they are willing to visit from their selection of retailers. In some cases the default number may be two. This ensures that the user is not sent to too many locations in order to get their ingredients.

In a similar fashion, other factors besides budget may be considered by the system. For example, locally sourced items (when such information is available), may be a factor in determining where the user shops. Likewise, ingredients may be substituted based upon seasonality of the items and/or geographic location of the user (a user may wish to have ingredients that can be grown in their geographic location rather than ingredients that must be shipped in long distances.

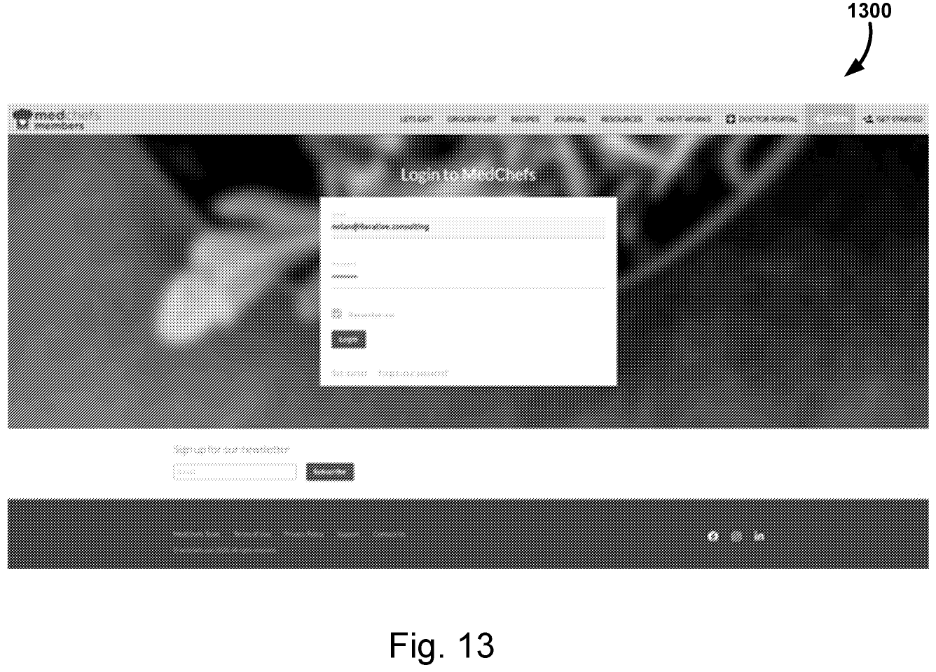

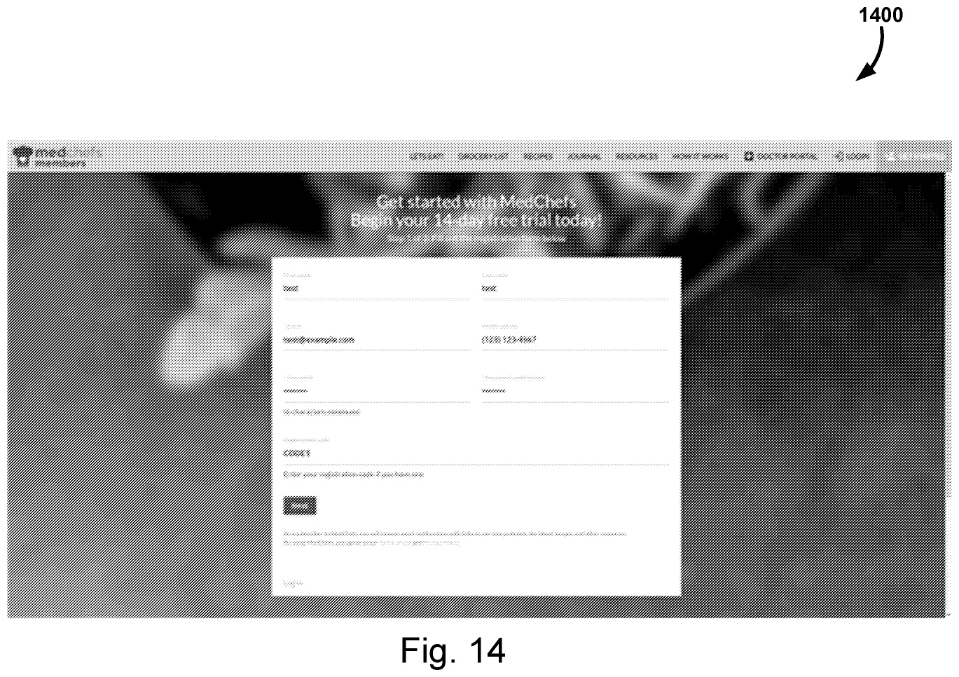

Now that the value-add services have been described in considerable detail, attention will be focused upon example illustrations of screenshots of the system in application. For example, FIG. 13 provides an example login page for a desktop application, shown generally at 1300. This screen allows the user to use a username/password pair to access the system, signup for the service, and sign-up for informational newsletters.

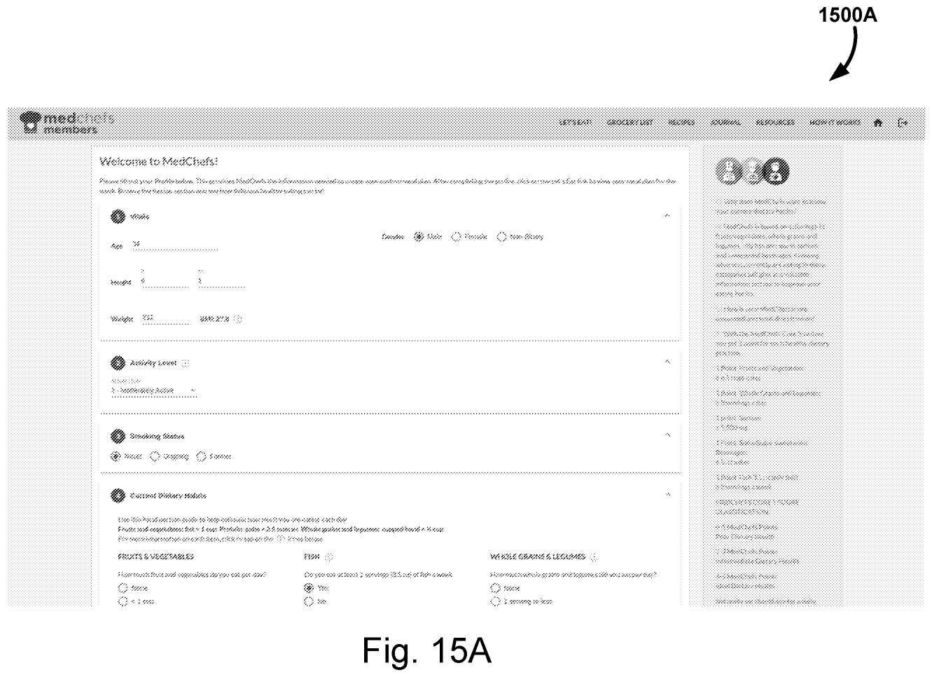

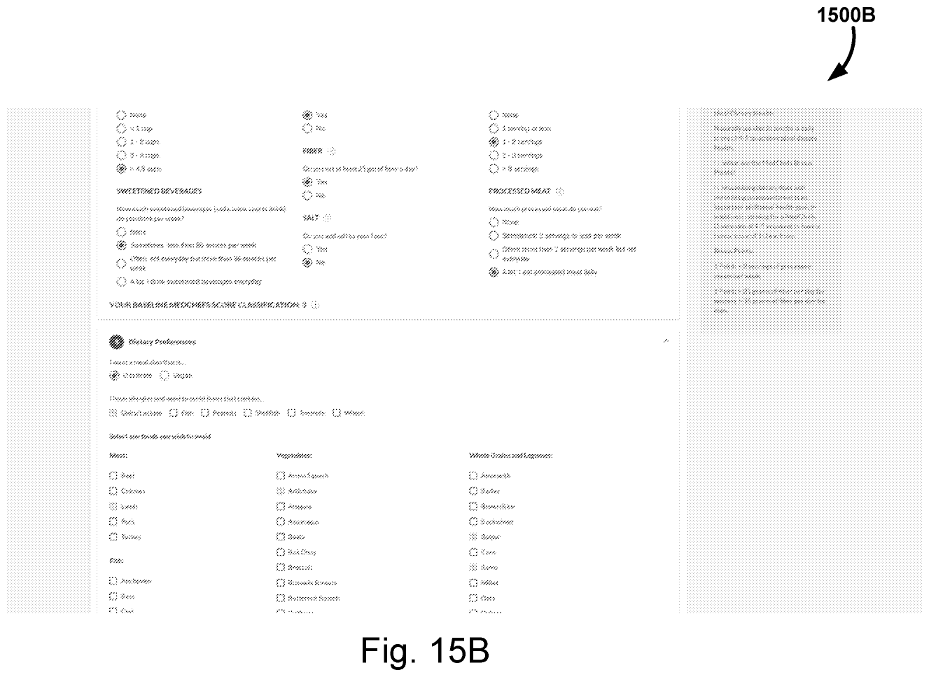

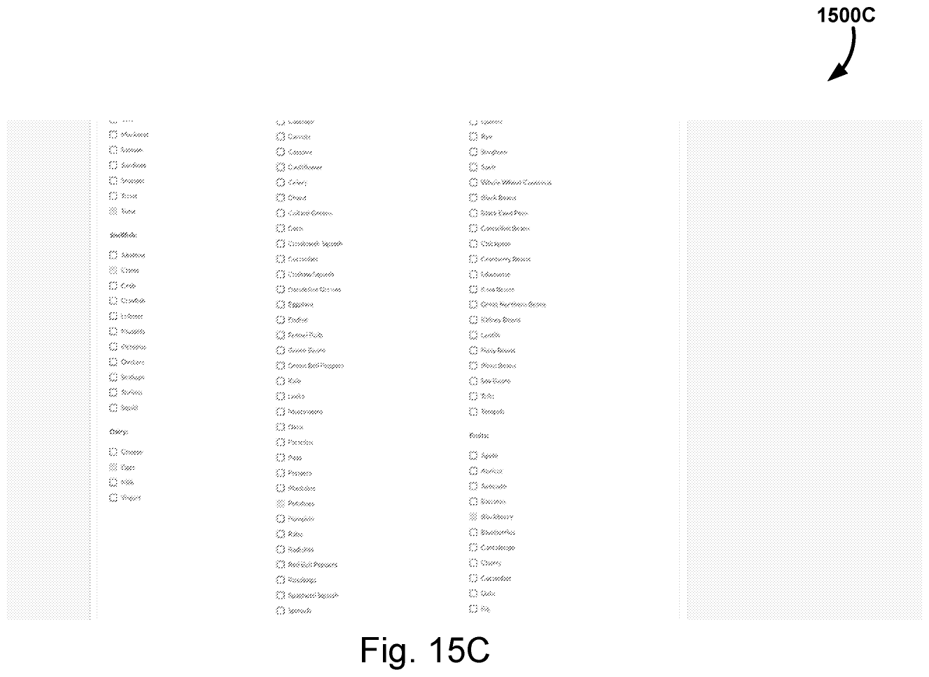

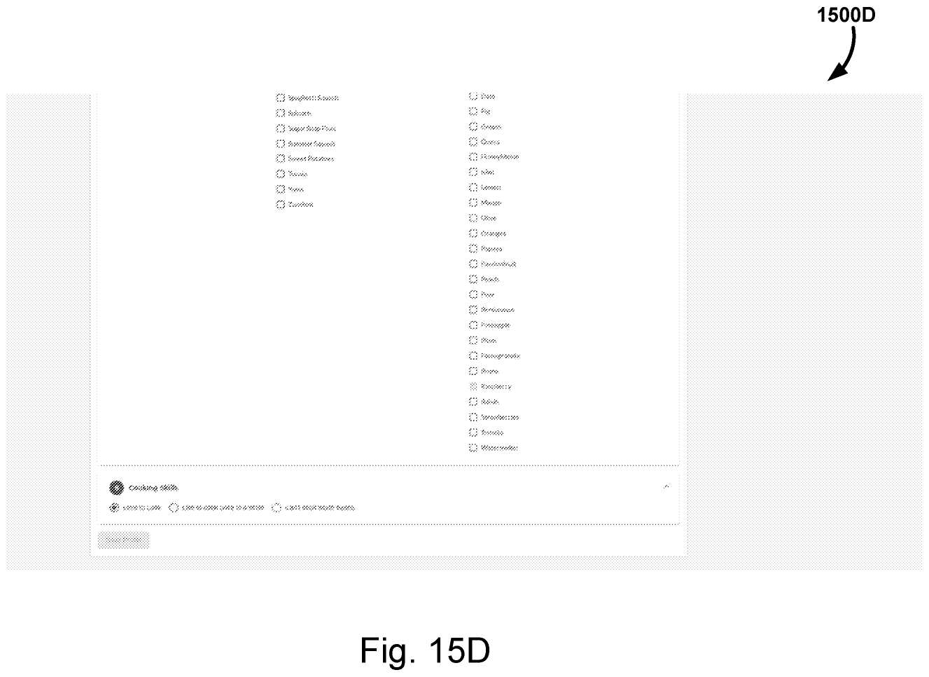

FIG. 14 provides an interface for initiating the signup process, shown generally at 1400. The user is asked for their name, email address, a password (with confirmation, and a registration code if available. After inputting this basic information, the user is redirected to a page were their profile is expanded with additional basic information related to their biography (e.g., age, gender, height, and weight), activity levels, smoking status, existing dietary habits, cooking skill level, and importantly their dietary preferences/palate profile, as seen in relation to FIGS. 15A-D.

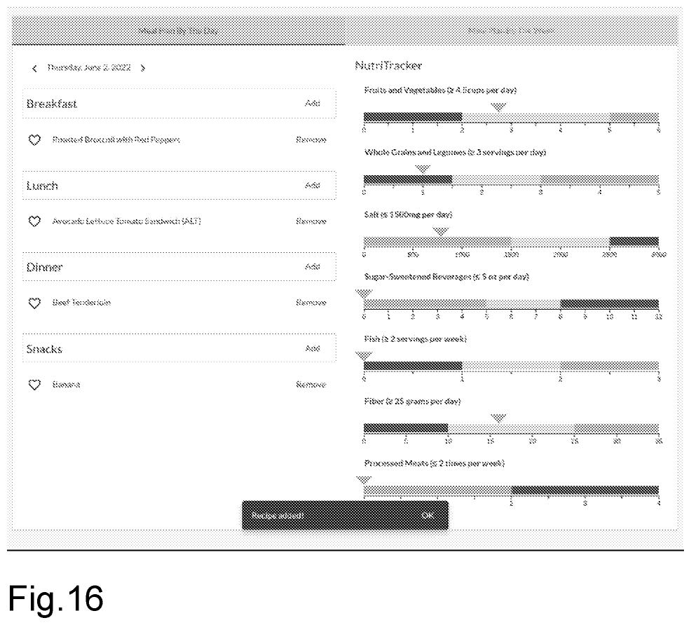

After signing in, or profile generation, the user may be directed to their main dashboard, and seen in relation to FIG. 16. On this page, a meal plan by day is shown, along with the nutritional components of the day's meal plan (and its impact on the week's nutritional status). This nutritional metrics illustrated on this example screenshot are designed to be easily understood by the user, and are thus presented as simple line diagrams that are color coded for ease of reading. On this screen, a tab on the top portion of the screen enables the user to toggle between the daily meal plan and the weekly meal plan schedule.

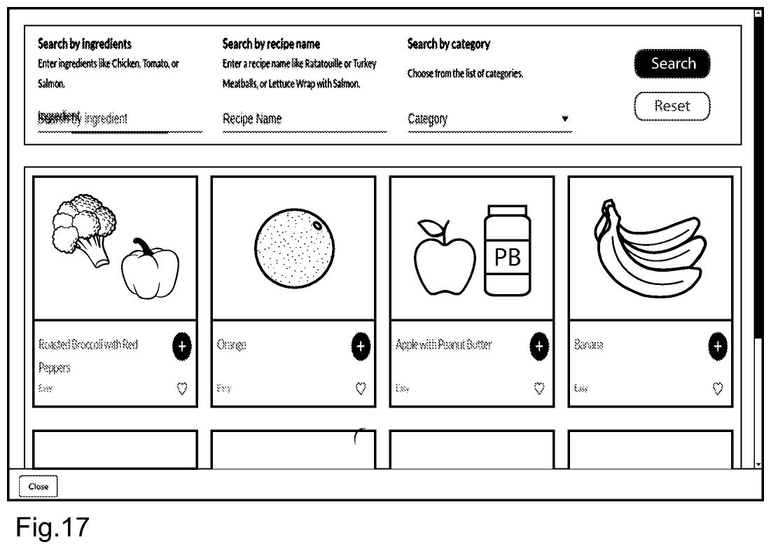

FIG. 17 presents a recipe library that is available to the user. Form this library, the user is able to add additional meals to the meal plan and indicate their preference for a given recipe (which the system may incorporate more frequently in the meal planning process, in some embodiments. Recipes are searchable by ingredients, name and by category to make identifying a particular meal easier for the user.

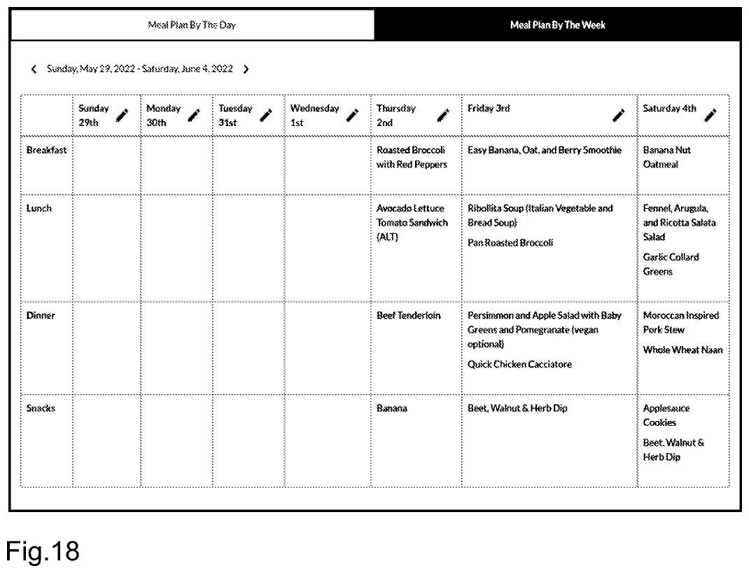

As noted before, the user is able to toggle between the daily meal plan and a weekly schedule of meals. FIG. 18 provides an example illustration of said weekly schedule interface page. The user is able to advance or go back between weekly meals. In this example, a calendar week is displayed. In some other embodiments, the display may be a rolling period of a configurable number of days. In such embodiments, this allows the user to always know what the next few days' meals are going to be.

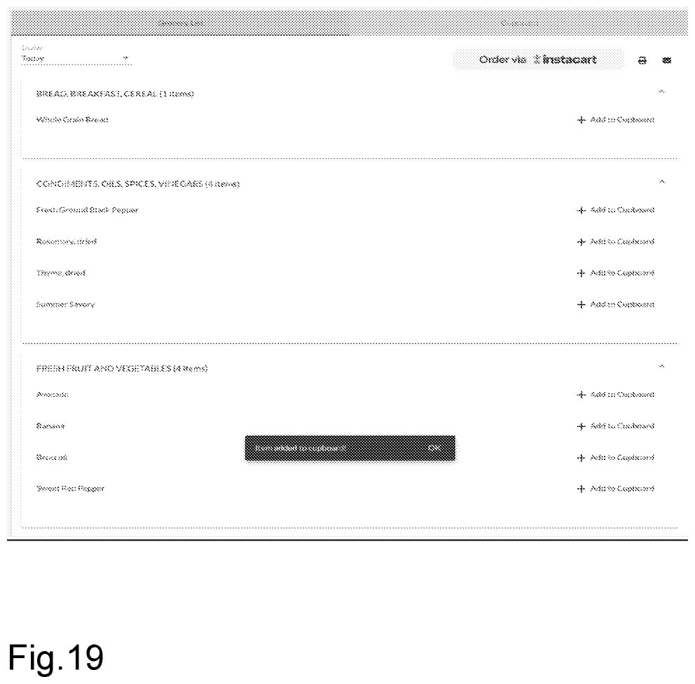

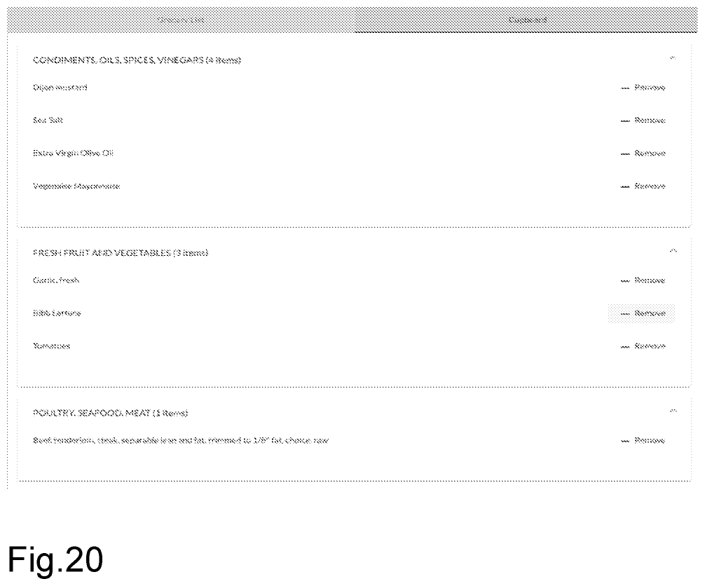

The user is also able to view their grocery lists for the upcoming meals, as seen in FIG. 19. The user is able to add items that are already owned from the ingredient list to their inventory of what's in their ‘cupboard’. This allows the user to more easily track their ingredient needs. As seen here, the entire shopping list may be ordered easily via a single click from Instacart. In other embodiments, the user may be presented a variety of convenient options for adding the ingredients to other delivery services, or individual retailer's shopping lists through their native applications/loyalty programs. The final grocery list after removing items to the cupboard are listed as see in the example interface illustrated in relation to FIG. 20.

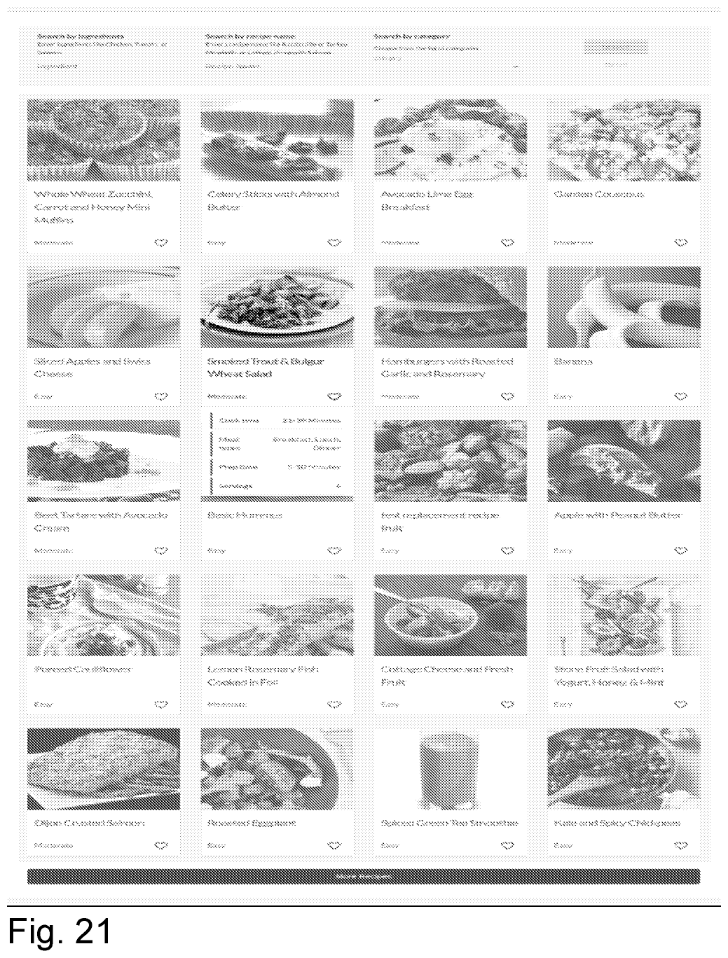

FIG. 21 provides another example illustration of the recipe search page, this time formatted for a mobile device screen. As can be seen, by selecting a given recipe, a pulldown menu provides basic information regarding the recipe, including the cook time, meal type, prep time and servings.

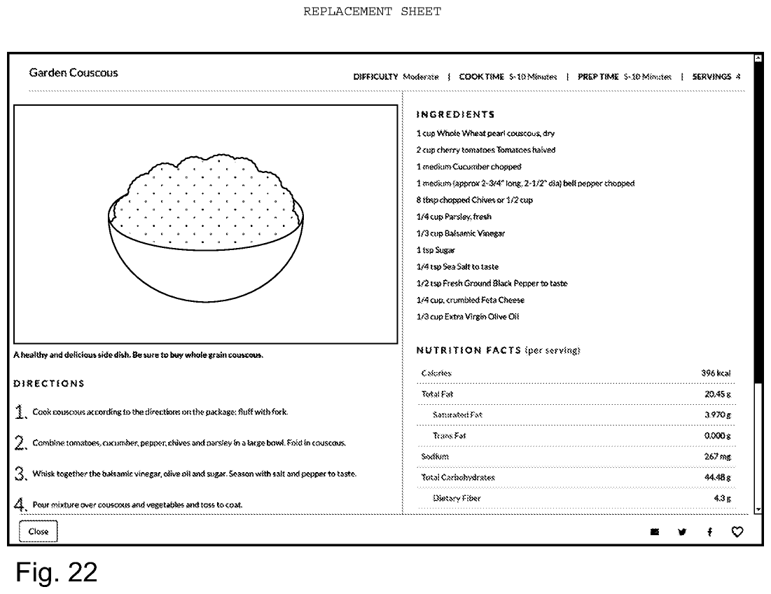

When a recipe is selected, an interface, such as the one illustrated in relation to FIG. 22, is presented to the user. In this example interface, an image of the dish is provided, along with the ingredient list, cooking directions and nutritional information.

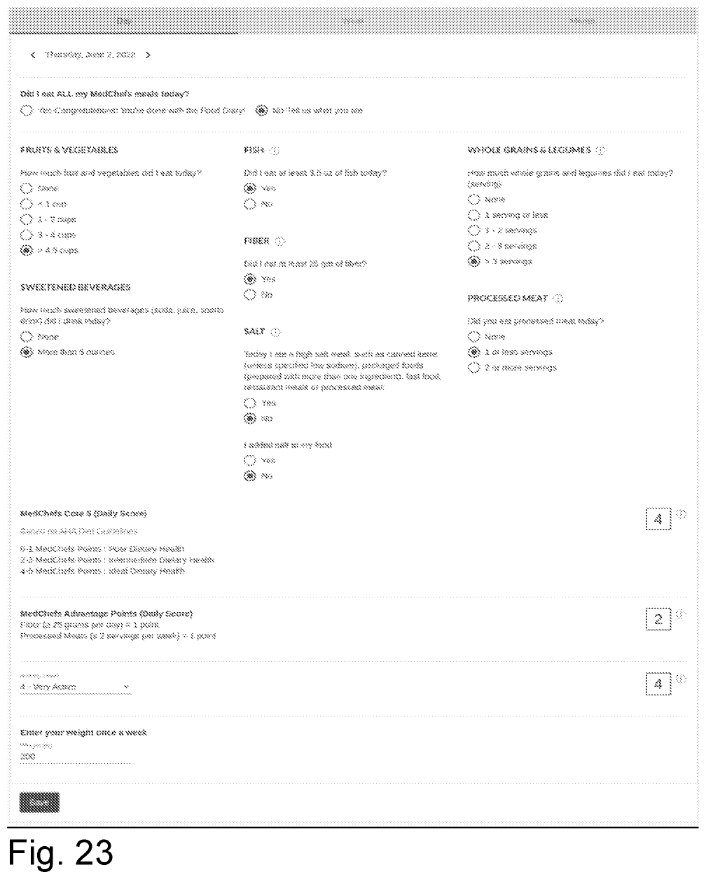

Periodically, the user is asked to provide feedback on their compliance regarding their dietary intake. FIG. 23 provides an example of such an interface. The user is able to simply select a radial button if they were compliant with their meal plan for the day. However, if they were non-compliant, the system may request that they provide details regarding what they actually consumed. In some embodiments, a very simple set of questions are provided to the user in order to simplify the reporting process. While this is the most user friendly, it also limits the nutritional information that can be collected, as gross estimations regarding micro and macro nutrients are made based upon the limited feedback. On the other extreme, individual ingredients to the food eaten are supplied by the user, which then allows very accurate determination of the nutritional components consumed. Generally, the system aims somewhere between the extremes, and collects enough information to be useful, without being cumbersome for the user to report. An example of this is presented in relation to the present figure. Other important information, such as activity and weight may likewise be collected.

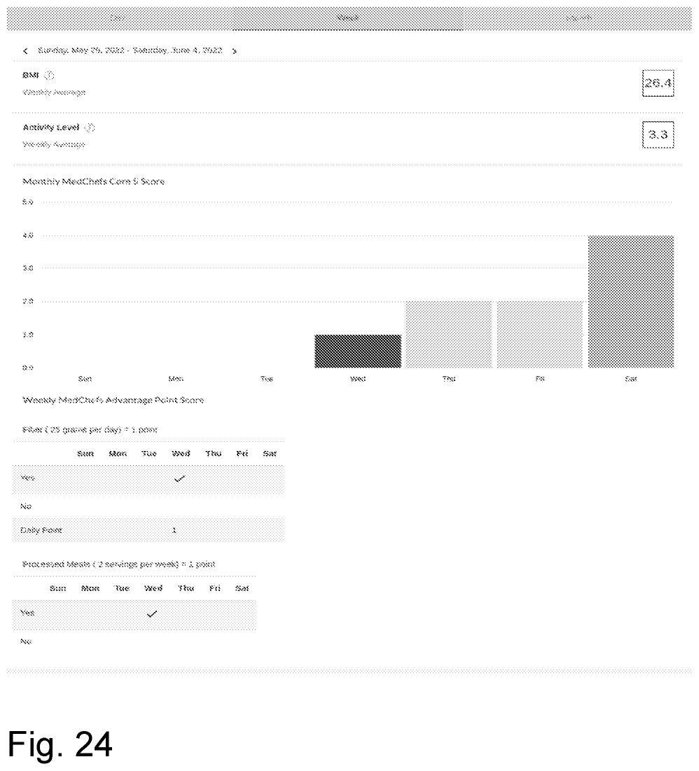

The collected information may be leveraged to generate a set of scores, as seen in FIG. 24. These scores may be plotted in easy to read, color coded graphs for consumption by the user, as indicated in the present figure. BMI measurements and average weekly activity levels may likewise be provided.

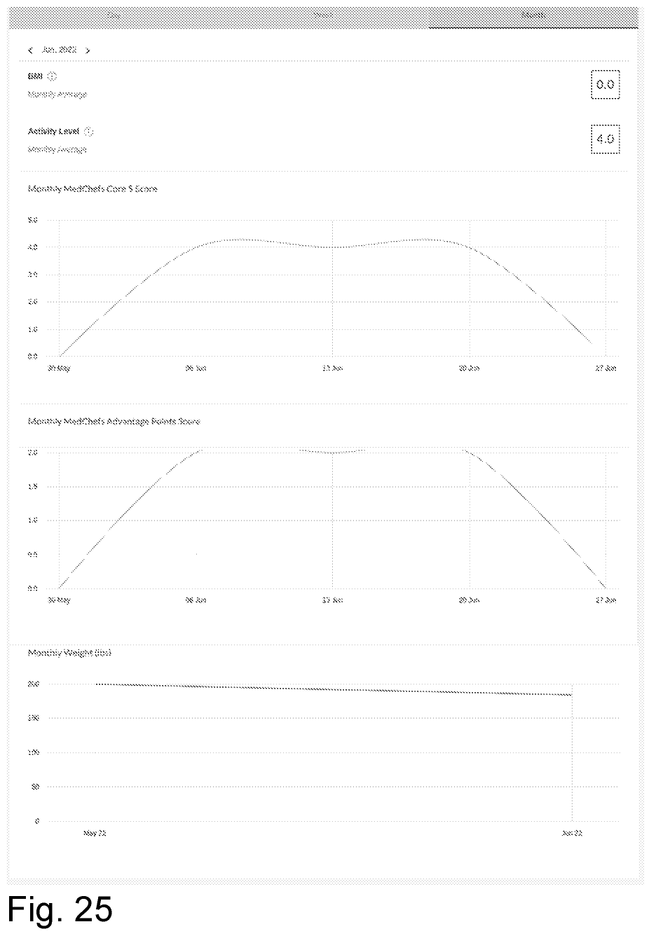

These analytics may be shown on a daily, weekly and monthly basis. Monthly trends may be plotted on a chart for the user to easily read, as seen in relation to FIG. 25. Monthly average of BMI, activity levels, score charts and weight trends are all illustrated.

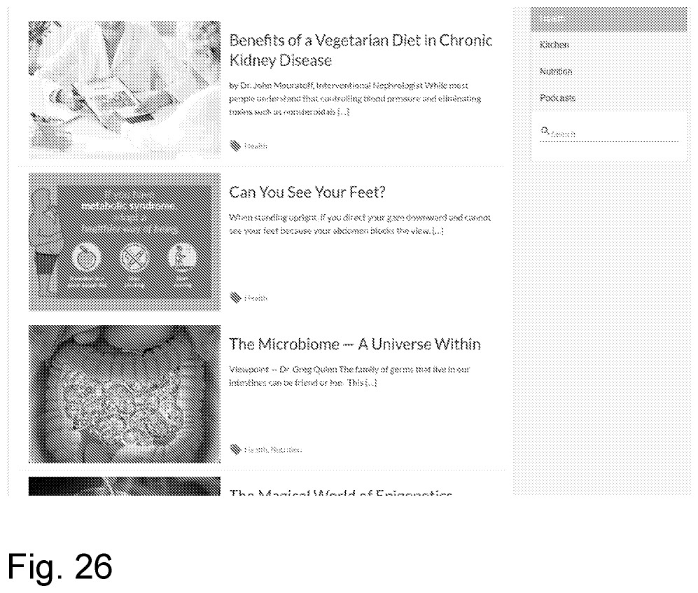

The system also provides curated resources, as discussed in significant detail above, for the user, as seen in relation to FIG. 26. Curated articles, videos and podcasts may be presented preferentially to the user, and the system further allows the user to search the resources by type and keywords (e.g., tags, and titles).

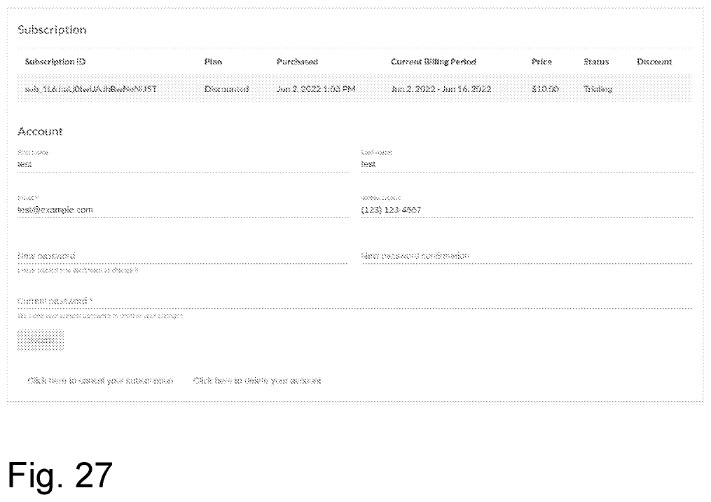

FIG. 27 provides an illustration of an example interface for account management, including subscription information and account login details.

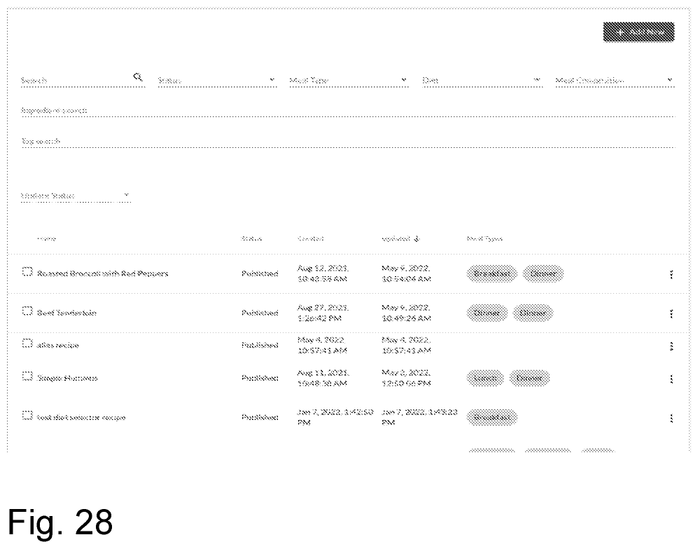

FIG. 28 provides an illustration of an example interface where a curator of the system may search recipes and then classify them according to the type of meal, composition of the meal, and allows publishing of the meal within the recipe repository. In some embodiments, the system takes the ingredient list and automatically calculates macro and micro nutritional data for the recipe. In some embodiments, the curator may access the recipe and make alterations to the ingredients (e.g., reduce the butter used, substitute milk for cream, etc.).

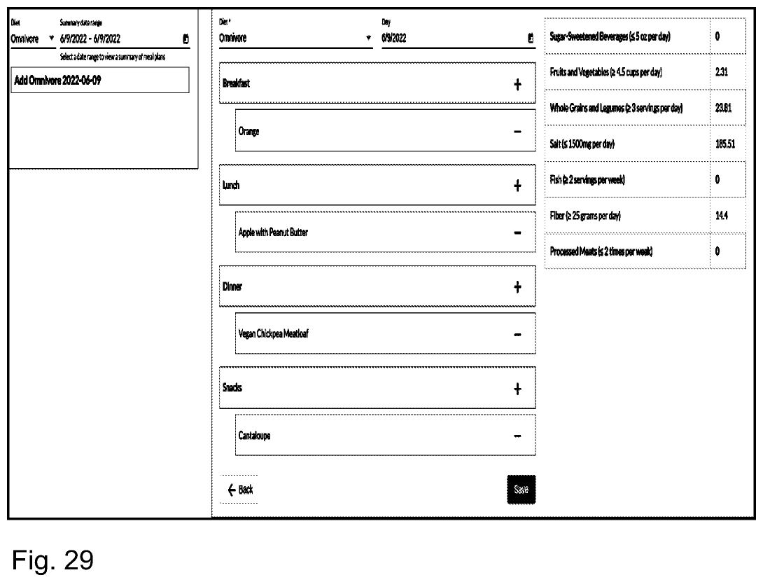

FIG. 29 provides an illustration of an example a curated meal plan. The curator and/or user has the ability to add and remove recipes from the meal plan. Macro nutritional summary of the meal plan may be seen in the pane on the right hand side of the interface.

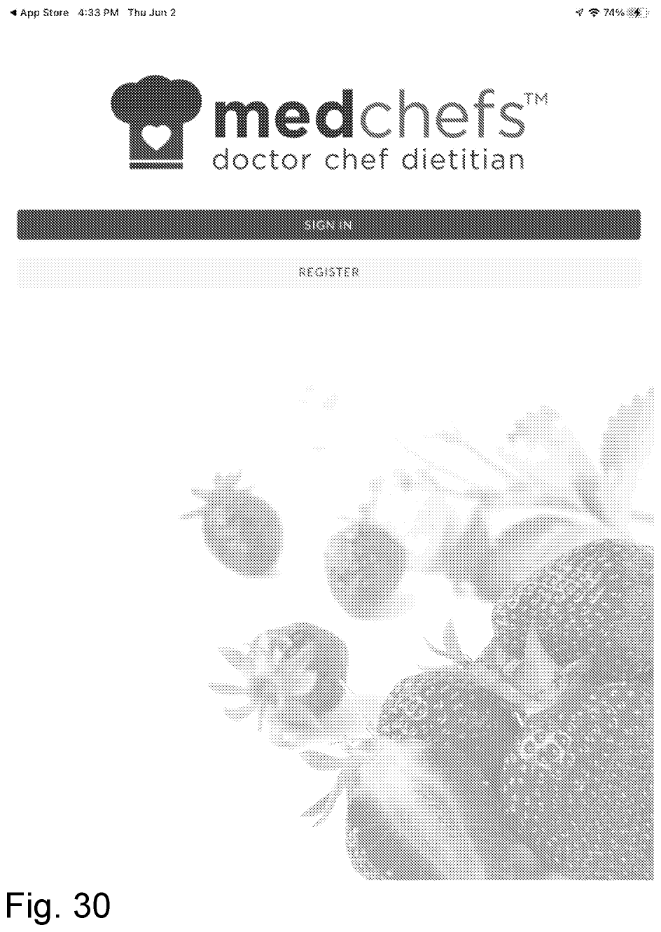

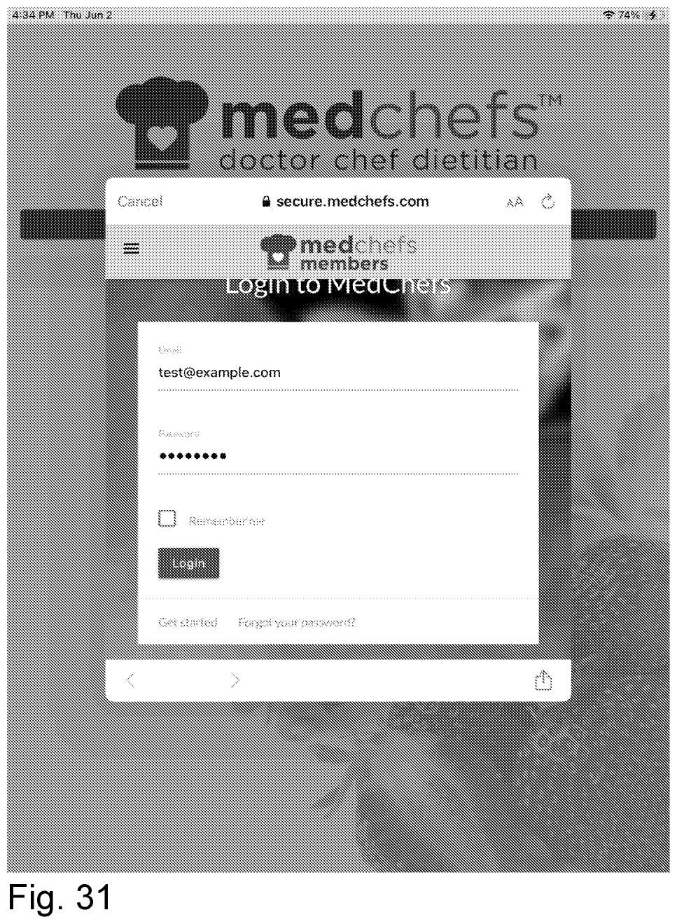

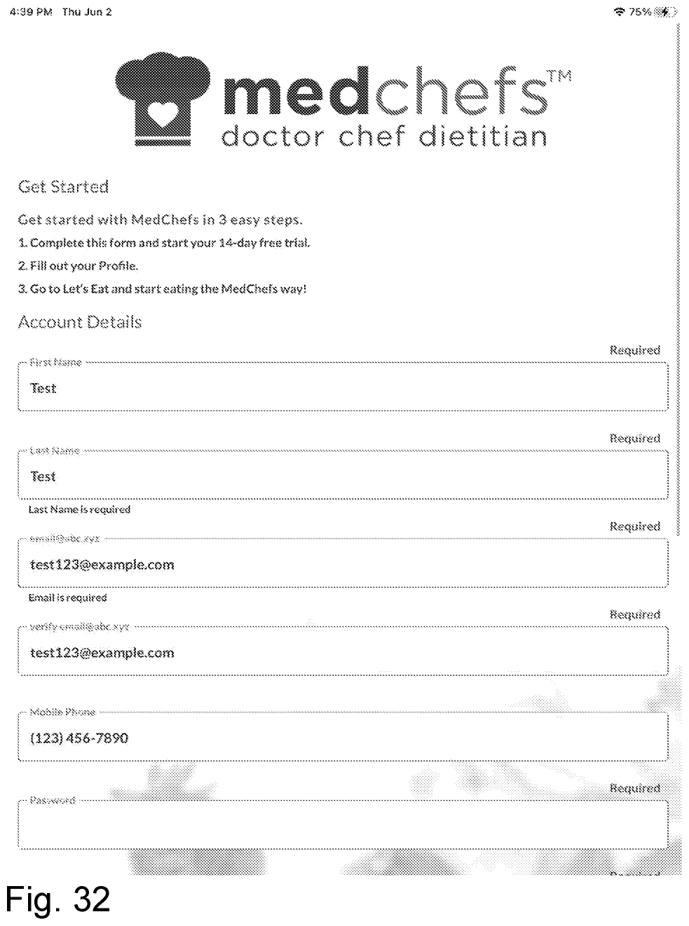

Turning to FIG. 30, it should be noted that many of the same interfaces may be likewise available on the mobile devices. Here, the login/signup screen on a mobile device can be seen. On FIG. 31, a screen is illustrated where the user is authenticating into the application, whereas FIG. 32 illustrates an example mobile interface for the signing up for the MedChefs services.

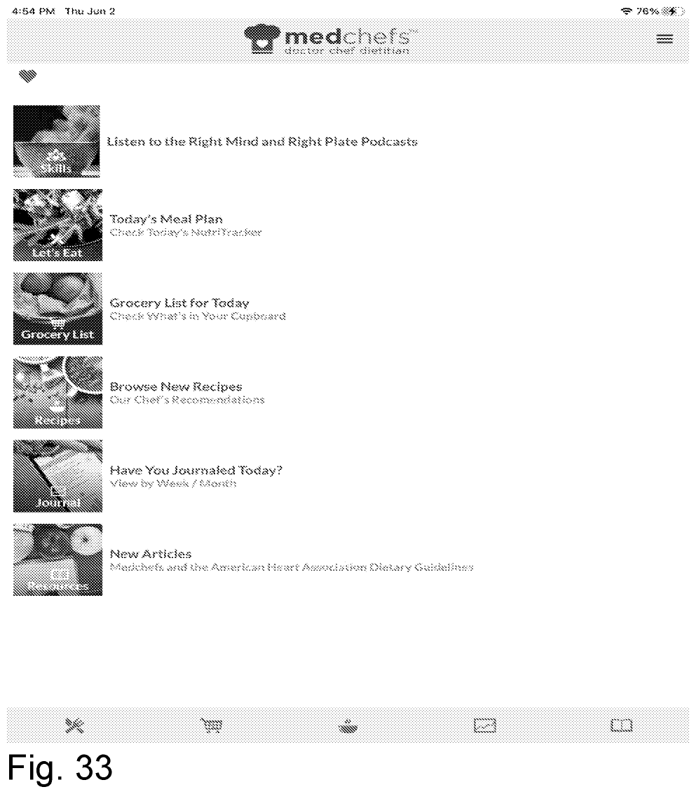

FIG. 33 illustrates the mobile device version of an example interface for the providing of curated resources, including articles, videos and podcasts that have been selected for the user's consumption.

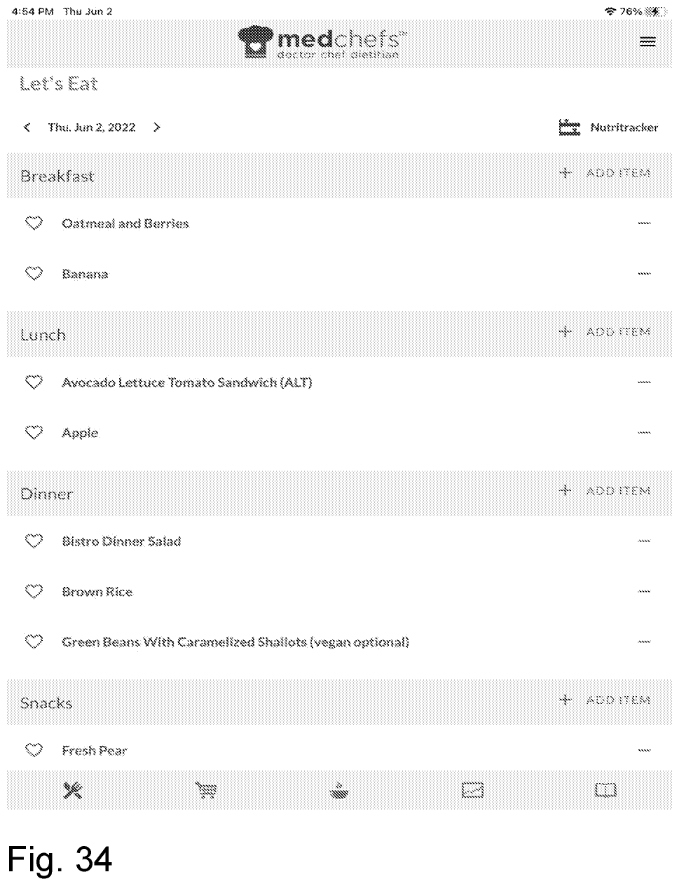

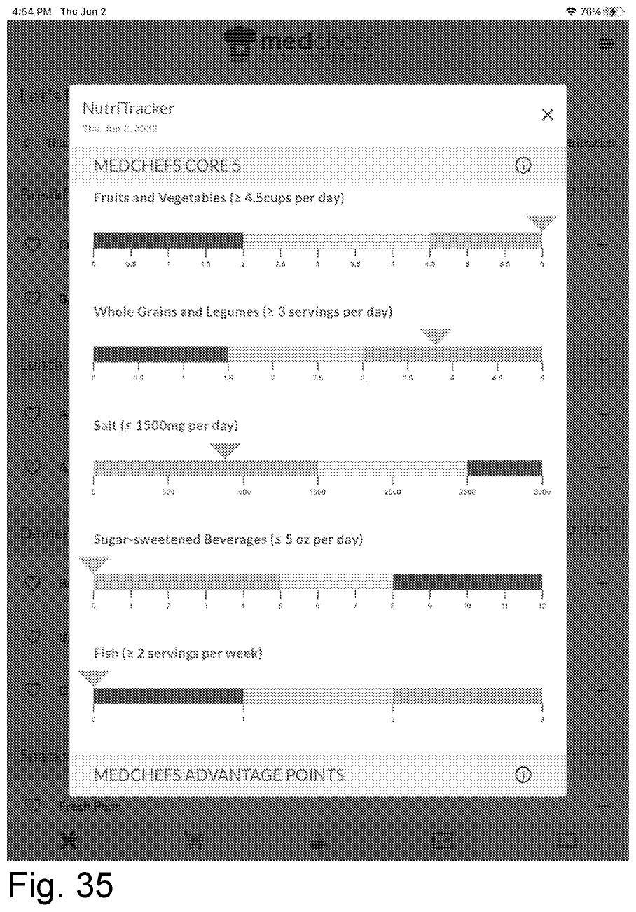

FIG. 34 provides an illustration of the mobile device version of a daily meal plan. The user is able to scroll between the different days or select the nutritional tracker for the meal plan. FIG. 35 illustrates the example pop-up screen when the user selects the nutritional tracker. Again, this example interface is designed to provide the user with a quick overview of macro nutritional goals and how well they are doing using basic sliding scales which are color coded. In some embodiments, a “good” score may be in a green coded portion, a “fair” score in a yellow portion of the scale, and a “bad” score in a red portion of the sliding scale. The total scores for the user may likewise be displayed on this example interface.

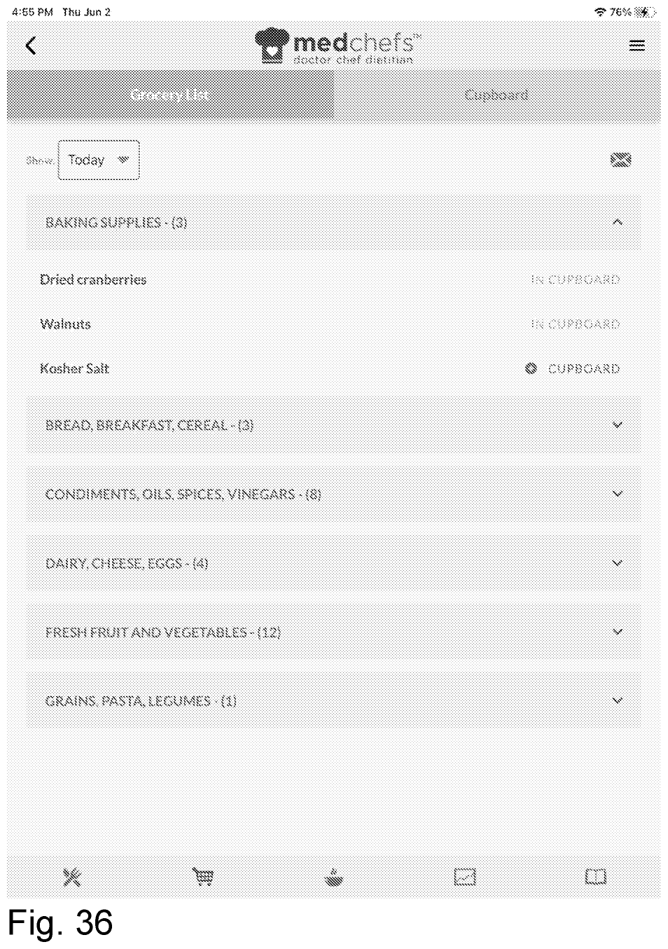

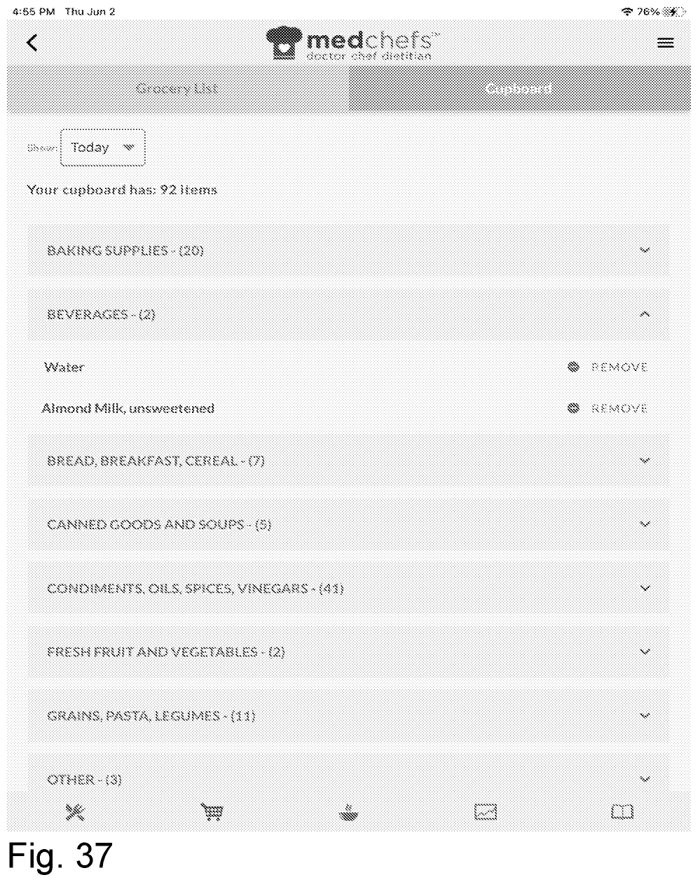

FIG. 36 provides an illustration of an example mobile interface for the shopping list which is automatically generated for the daily meal plan. A drop down menu allows the user to show other shopping lists for multiple days (as a user generally does not go shopping every day). In a similar vein, FIG. 37 illustrates an example interface for the user's cupboard, which contains items that the user already has access to and does not need to purchase. For convenience, the cupboard is organized by ingredient types.

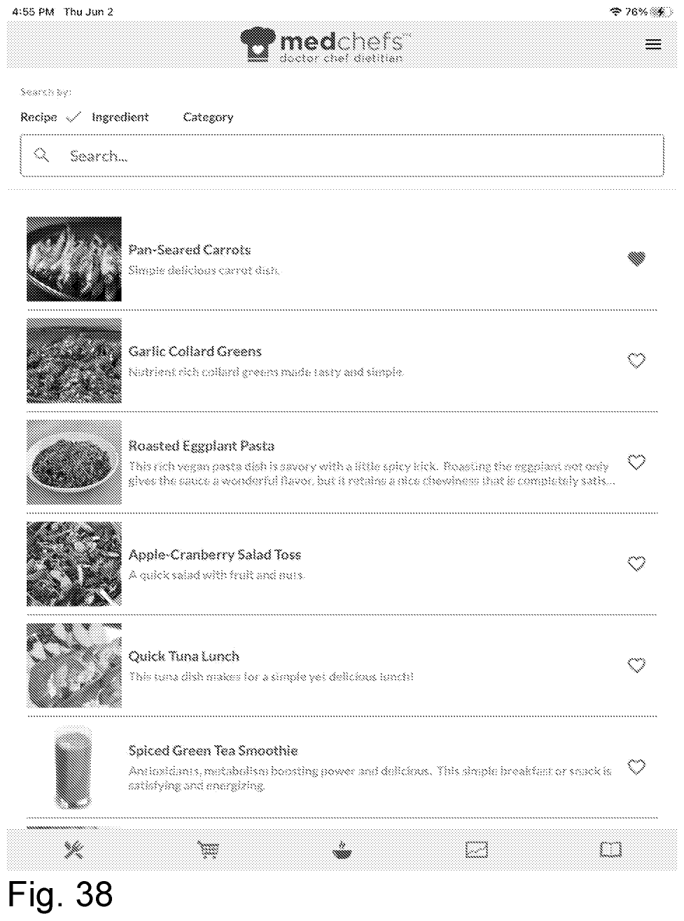

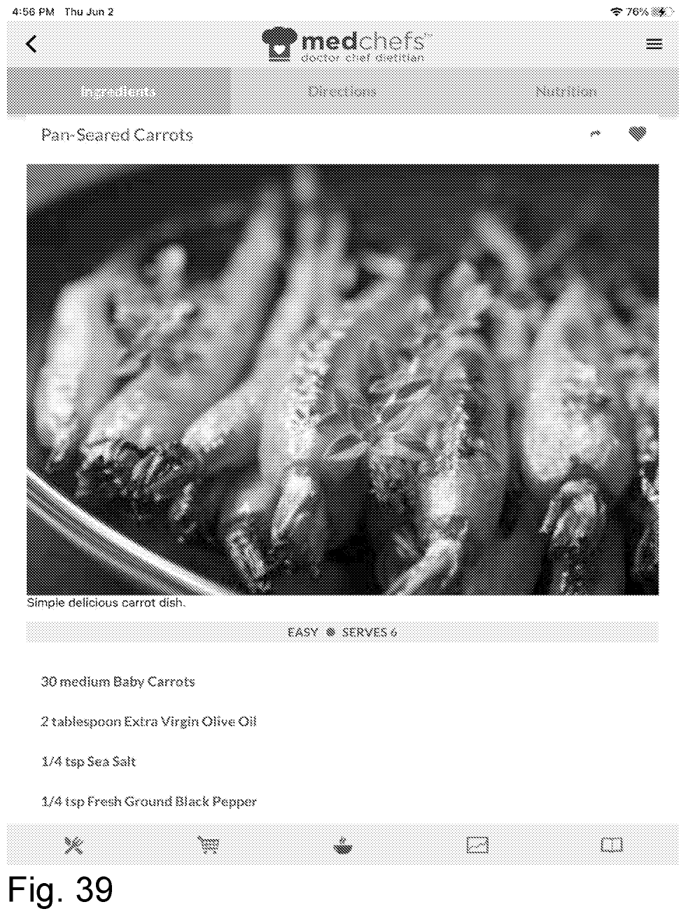

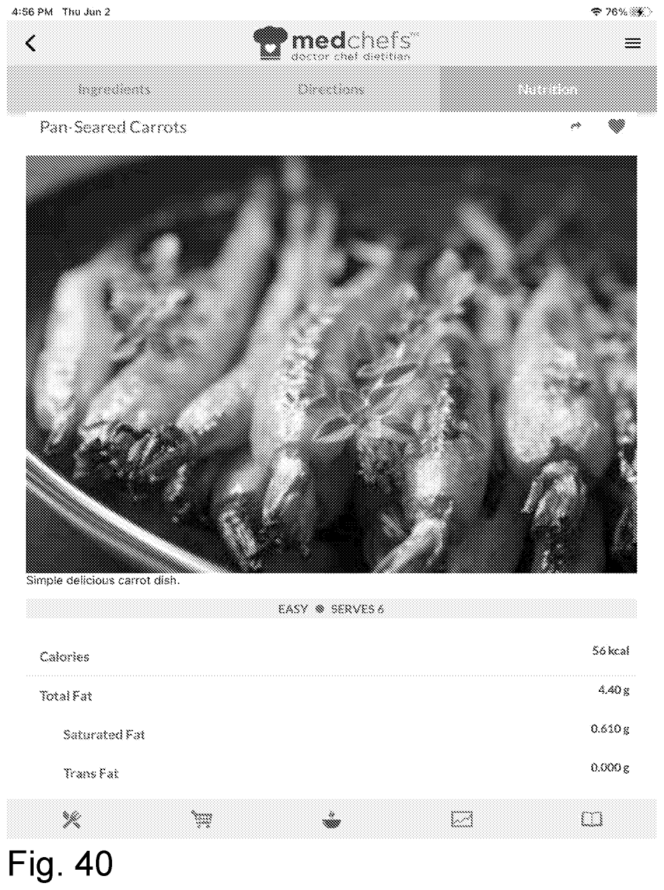

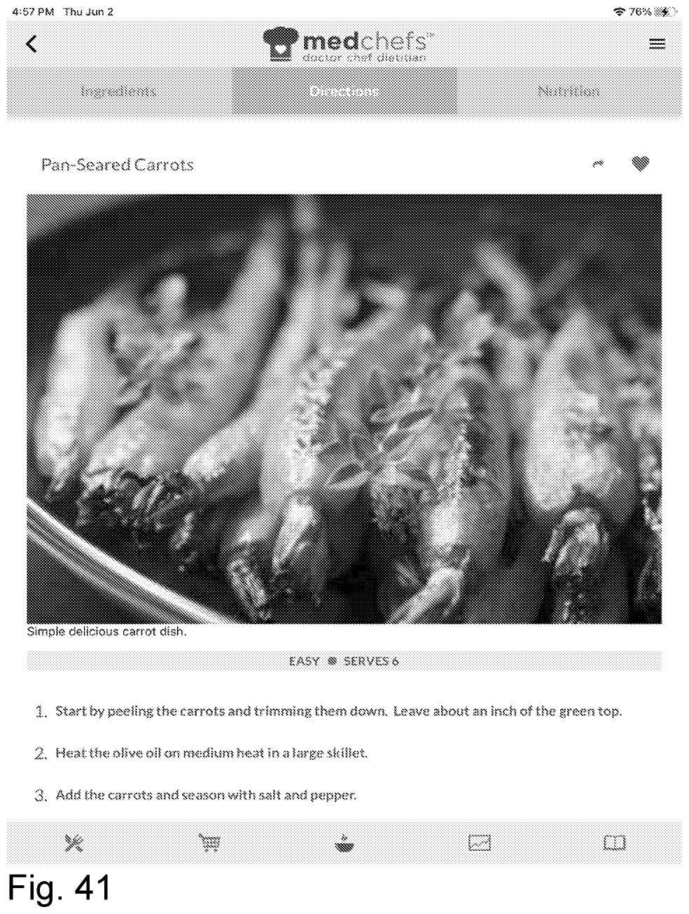

FIG. 38 provides an illustration of an example mobile device interface for the display of various recipes for searching by keyword, ingredients and/or category. The user may then favorite the recipe and view the recipe for more details. FIG. 39 is an illustration of an example mobile interface once the user selects the recipe for viewing in greater detail. Serving number, ease of preparation, ingredients and the like may all be displayed to the user. FIG. 40 shows the nutritional value for the recipe that is available for viewing by the user. By scrolling down further the steps to prepare the dish are also provided, as seen in relation to FIG. 41.

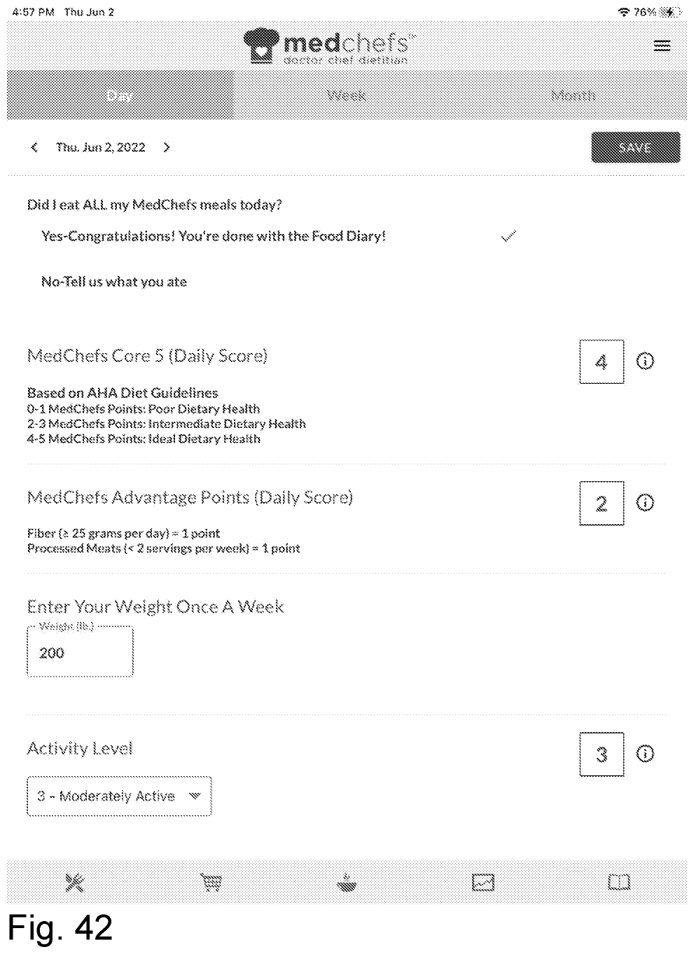

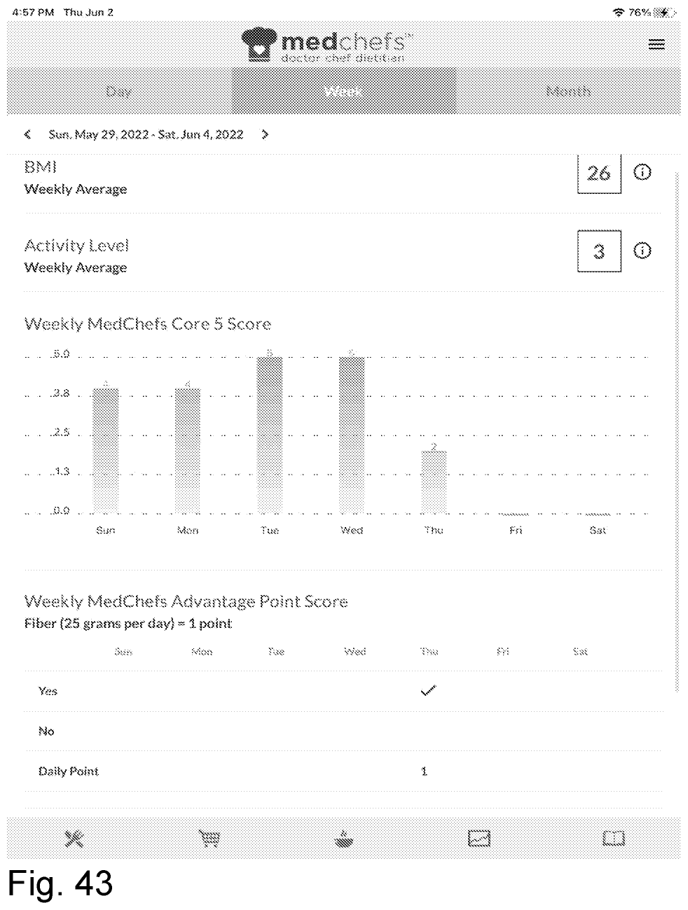

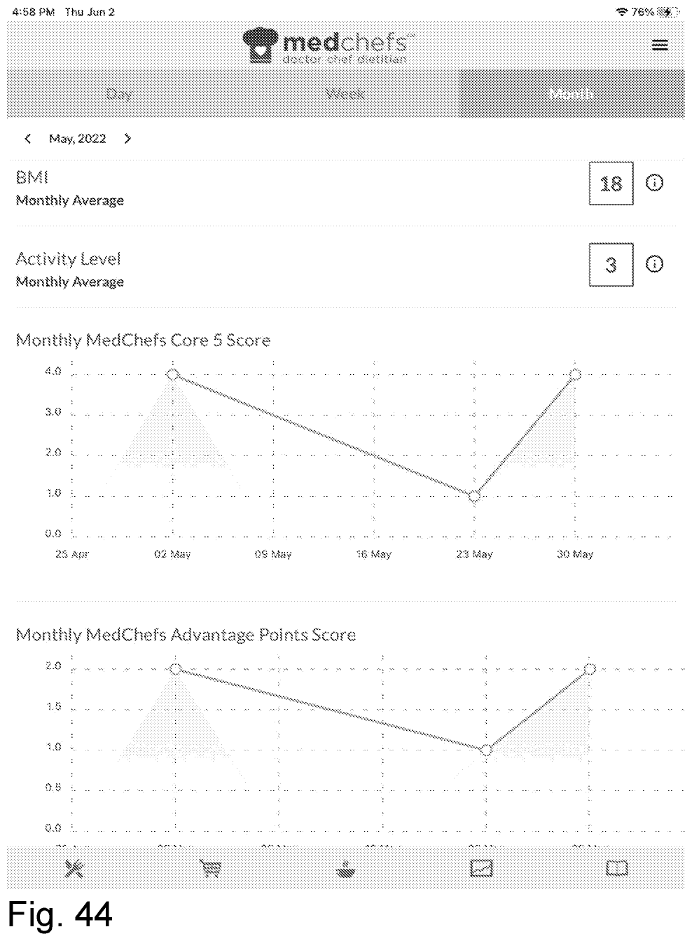

FIG. 42 provides an illustration of an example interface whereby the user is able to report on their compliance with the meal plan. In this example screen, the user has indicated that they complied with the meal plan, and the system uses this information to generate scores for the user. This may be viewed on a day to day basis, or may be viewed as a weekly or monthly metrics. A weekly view may be seen in relation to FIG. 43, whereas monthly metrics are displayed in FIG. 44.

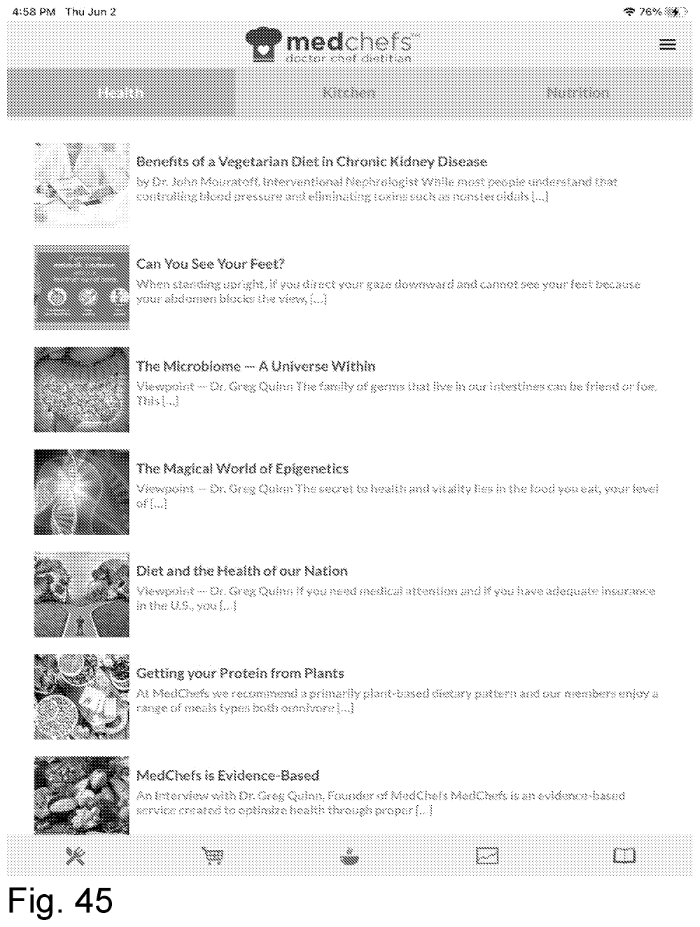

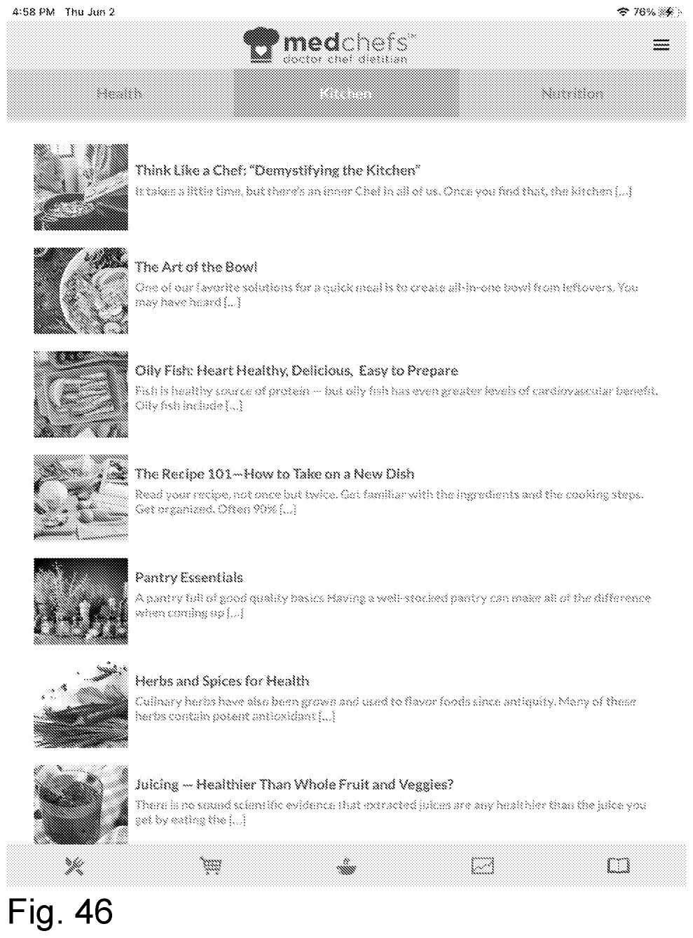

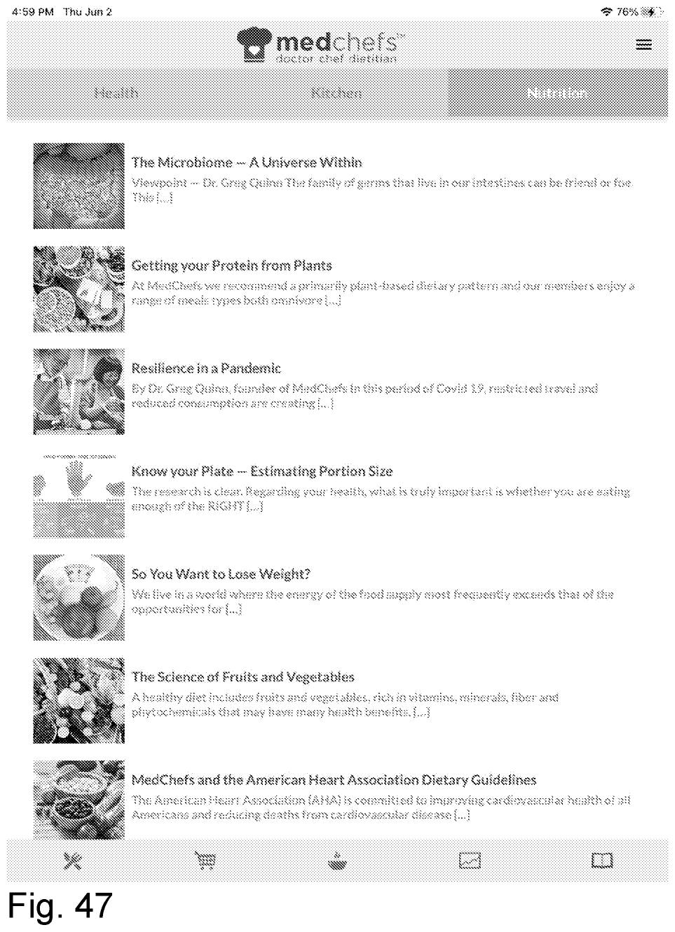

Moving on, FIG. 45 an illustration of an example mobile device interface for the display of resources to the user is provided. These resources may be divided by categories which are curated for the user's consumption. FIG. 45 illustrates resources that are related to the ‘health’ category, while FIG. 46 relates to the ‘kitchen’ category. FIG. 47 shows the resources belonging to the ‘nutrition’ category.

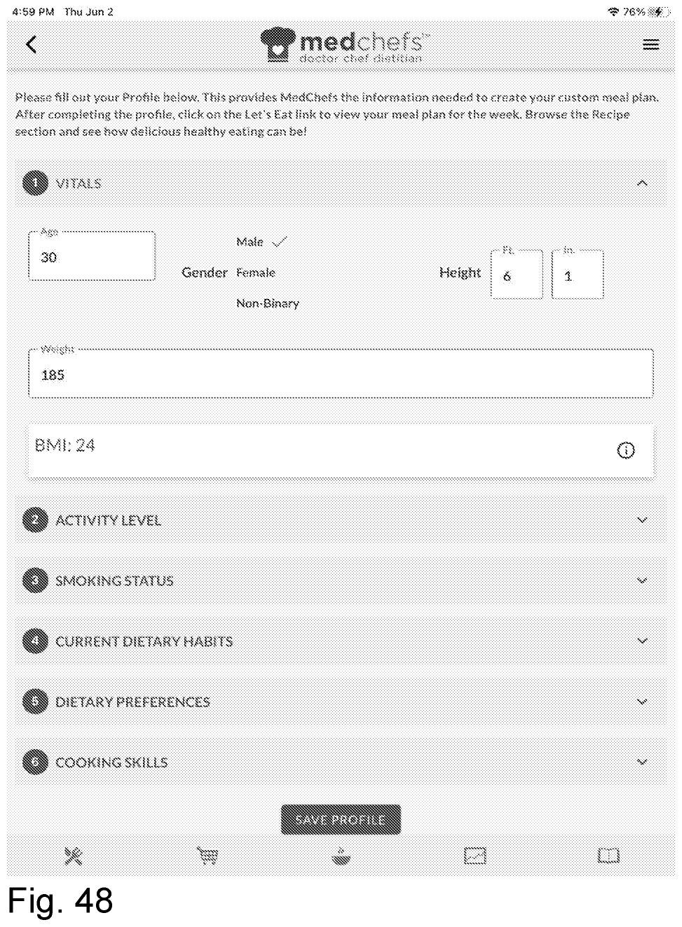

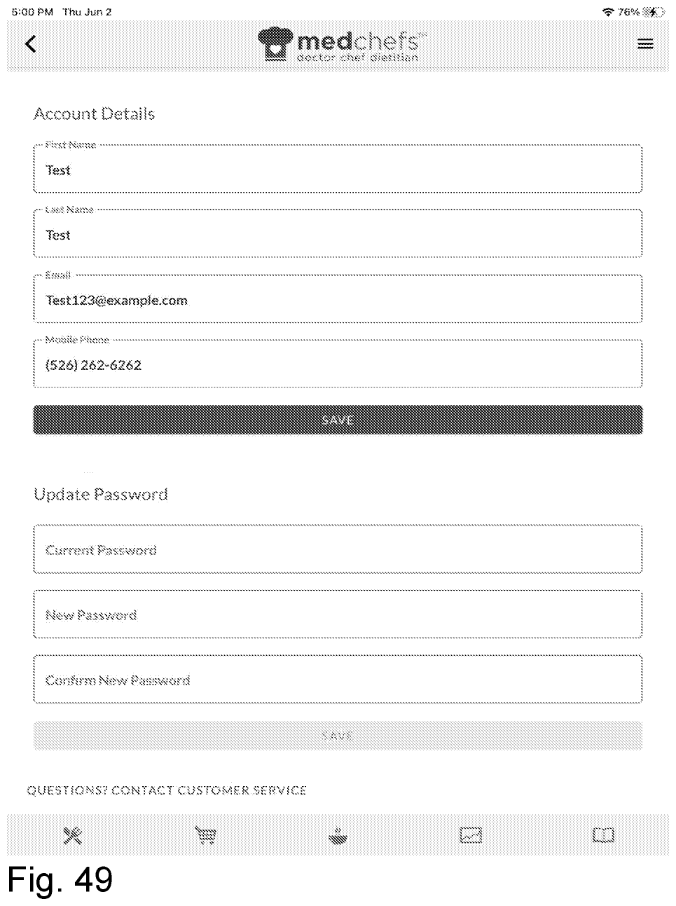

FIGS. 48 and 49 provide illustrations of example interfaces for when the user first sets up their profile. As noted earlier in relation to the desktop version of the system, the user inputs data related to her authentication, vital information (which may include existing or at-risk pathology data), activity levels, smoking status, current dietary habits, dietary preferences and cooking skills. The user's profile may be augmented with other data sources, such as the objective data sources previously discussed.

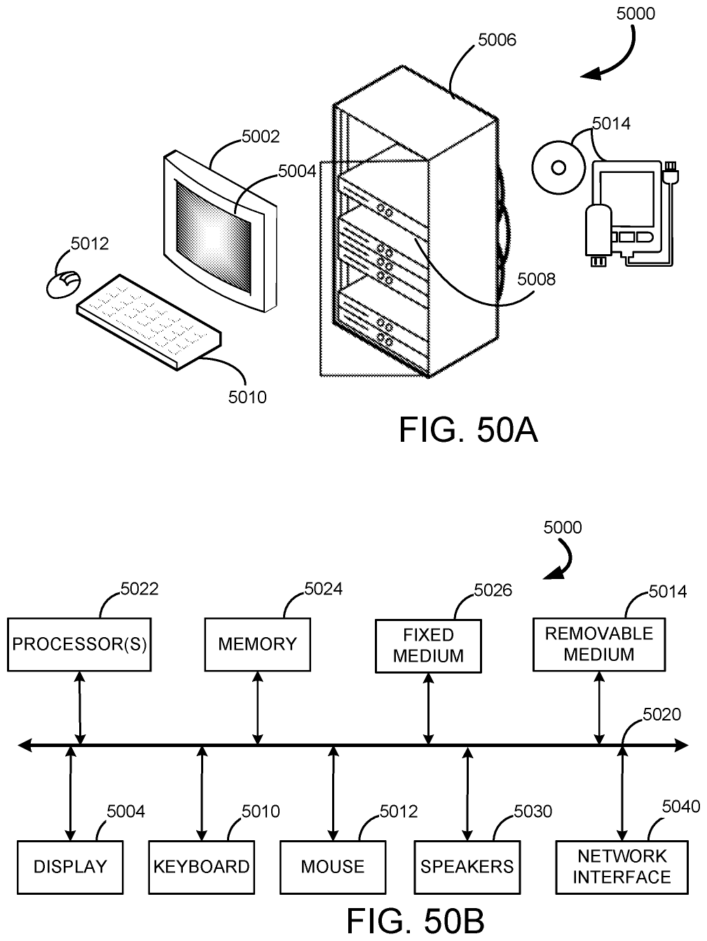

Now that the systems and methods for a nutritional management system have been provided, attention shall now be focused upon apparatuses capable of executing the above functions in real-time. To facilitate this discussion, FIGS. 50A and 50B illustrate a Computer System 5000, which is suitable for implementing embodiments of the present invention. FIG. 50A shows one possible physical form of the Computer System 5000. Of course, the Computer System 5000 may have many physical forms ranging from a printed circuit board, an integrated circuit, and a small handheld device up to a huge supercomputer. Computer system 5000 may include a Monitor 5002, a Display 5004, a Housing 5006, server blades including one or more storage Drives 5008, a Keyboard 5010, and a Mouse 5012. Medium 5014 is a computer-readable medium used to transfer data to and from Computer System 5000.

FIG. 50B is an example of a block diagram for Computer System 5000. Attached to System Bus 5020 are a wide variety of subsystems. Processor(s) 5022 (also referred to as central processing units, or CPUs) are coupled to storage devices, including Memory 5024. Memory 5024 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable form of the computer-readable media described below. A Fixed Medium 5026 may also be coupled bi-directionally to the Processor 5022; it provides additional data storage capacity and may also include any of the computer-readable media described below. Fixed Medium 5026 may be used to store programs, data, and the like and is typically a secondary storage medium (such as a hard disk) that is slower than primary storage. It will be appreciated that the information retained within Fixed Medium 5026 may, in appropriate cases, be incorporated in standard fashion as virtual memory in Memory 5024. Removable Medium 5014 may take the form of any of the computer-readable media described below.

Processor 5022 is also coupled to a variety of input/output devices, such as Display 5004, Keyboard 5010, Mouse 5012 and Speakers 5030. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 5022 optionally may be coupled to another computer or telecommunications network using Network Interface 5040. With such a Network Interface 5040, it is contemplated that the Processor 5022 might receive information from the network, or might output information to the network in the course of performing the above-described nutritional management. Furthermore, method embodiments of the present invention may execute solely upon Processor 5022 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this disclosure. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 5000 can be controlled by operating system software that includes a file management system, such as a medium operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, Glasses with a processor, Headphones with a processor, Virtual Reality devices, a processor, distributed processors working together, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer (or distributed across computers), and when read and executed by one or more processing units or processors in a computer (or across computers), cause the computer(s) to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method for providing dietary recommendations to a user, the method comprising:
receiving palate preferences, physiological data and dietary constraints for a user;
generating a nutritionally optimized meal plan based upon macronutrient and micronutrient requirements;
cross referencing the optimized meal plan against the palate preferences and dietary constraints to identify dietary elements within the optimized meal plan that are in conflict with the palate preferences and dietary constraints;
responsive to the macronutrient and micronutrient requirements, substituting the identified dietary elements with substitutions to generate a final meal plan;
identifying a computing platform employed by the user;
formatting an output for the final meal plan based upon the computing platform;
presenting the output to the user;
receiving feedback from the user regarding compliance with the final meal plan; and
generating at least two scores based upon the feedback, wherein a first score is a nutritional compliance score, and a second score is a consumption characterization score.

2. The method of claim 1, further comprising providing curated resources to the user.

3. The method of claim 2, wherein the curated resources are responsive to the user's physiological data.

4. The method of claim 1, wherein the optimized meal plan is responsive to the user's physiological data.

5. The method of claim 1, further comprising collecting independently verified information regarding the user.

6. The method of claim 5, wherein the independently verified information includes information from at least one of a medical professional, a wearable device, a smart scale, or a smart exercise equipment.

7. The method of claim 1, further comprising providing at least one value added service to the user.

8. The method of claim 7, wherein the at least one value added service includes at least one of the automated generation of a shopping list, a grocery delivery service, a meal preparation service, and a coaching service.

9. The method of claim 1, further comprising:
receiving a digital image of a meal;
digitally parsing the image for color segments;
generating a nutritional score for the meal responsive to diversity of the color segments present, and wherein particular color segments are weighted differently.

10. The method of claim 9, wherein high contrast colors in the red, orange, green and yellow spectrum are weighted more than lower contrast colors.

11. The method of claim 1, wherein the nutritional compliance score is calculated as:

12. The method of claim 1, wherein the consumption characterization score is calculated as a point for each of consuming greater than approximately 25 grams of fiber in a 24 hour period, and consuming no greater than 2 servings of processed meats per 7 day period.

13. The method of claim 1, wherein the at least two scores includes an activity level score.

14. A computerized method for generating a shopping list for a user, the method comprising:
receiving palate preferences, physiological data and dietary constraints for a user;
generating a nutritionally optimized meal plan based upon macronutrient and micronutrient requirements;
cross referencing the optimized meal plan against the palate preferences and dietary constraints to identify dietary elements within the optimized meal plan that are in conflict with the palate preferences and dietary constraints;
responsive to the macronutrient and micronutrient requirements, substituting the identified dietary elements with substitutions to generate a final meal plan;
identifying all ingredients for the final meal plan;
aggregating the identified ingredients with ingredients from a plurality of other planned meals to generate a final ingredient list;
cross referencing the final ingredients list with a cupboard list to remove ingredients from the final ingredients list that are present in the cupboard list to generate a refined ingredients list;
receiving input from a user to remove ingredients from the refined ingredients list to generate the shopping list; and
outputting the shopping list to an electronic grocery application for a retailer or an aggregation grocery delivery service.

15. The method of claim 14, further comprising receiving feedback from a smart fridge to populate the cupboard list

16. The method of claim 14, wherein the removal of ingredients from the refined ingredients list populates the cupboard list.

17. The method of claim 14, further comprising querying the user regarding items in the cupboard list after a set time period.

18. The method of claim 14, further comprising querying the user regarding items in the cupboard list after a usage quantity over a plurality of meal plans.

19. The method of claim 14, wherein the outputted shopping list is automatically delivered to the residence of the user on a configurable cadence.

20. The method of claim 14, further comprising selecting at least one retailer for the shopping list by minimizing total cost of the shopping list.
